(19) United States
(12) Patent Application Publication
(10) Pub. No.: US 2011/0046928 A1
(43) Pub. Date: Feb. 24, 2011

(54) Process for making models of photons, electrons, magnitism, gravity and other things

(76) Inventor: John R. Ross, Del Mar, CA (US)

Correspondence Address: ROSS PATENT LAW OFFICE, P.O. BOX 2138, DEL MAR, CA, 92014, US

(21) Appl. No.: 12/806,375

(22) Filed: Aug. 11, 2010

Related U.S. Application Data
(63) Continuation-in-part of application No. 12/455,989, filed on Jun. 9, 2009.
Application No. 12/455,989 is a continuation-in-part of application No. 11/108,938, filed on Apr. 18, 2005, now abandoned.
Application No. 11/108,938 is a continuation-in-part of application No. 10/655,817, filed on Sep. 5, 2003, now abandoned.
Application No. 10/655,817 is a continuation-in-part of application No. 10/436,286, filed on May 12, 2003, now abandoned.
Application No. 10/436,286 is a continuation-in-part of application No. 10/251,577, filed on Sep. 21, 2002, now abandoned.
Application No. 10/251,577 is a continuation-in-part of application No. 09/908,297, filed on Jul. 17, 2001, now abandoned.

(51) Int. Cl. G06F 17/10

(52) U.S. Cl. 703/2

(57) ABSTRACT

A process for making models of very small things and very big things. Since the structure of the smallest and largest things in our Universe are unknown to science and hold the key to understanding how our Universe was created and functions, the Ross Model is a process for modeling the secrets of our Universe. In preferred embodiments the present invention is used to create models of subatomic particles (including tronnies, entrons, photons, electrons, protons) and other things in our Universe such as atoms, molecules, electricity, magnetism, gravity, Black Holes, galaxies, the Big Bang, and our Universe itself, including its shell.

### CROSS REFERENCE TO RELATED APPLICATIONS

This application is a Continuation-in-Part application of Ser. No. 12/455,989, filed Jun. 9, 2009 which was a Continuation-in-Part of Ser. No. 11/108,938 filed Apr. 18, 2005 which was a Continuation in Part of Ser. No. 10/655,817 filed Sep. 5, 2003, Ser. No. 10/436,286 filed May 12, 2003, Ser. No. 10/251,577 filed Sep. 21, 2002 and Ser. No. 09/908,297, filed Jul. 17, 2001, which was a Continuation-in-Part of Ser. No. 10/161,823 filed Jun. 3, 2002, now abandoned, all of which are incorporated herein by reference.

### FIELD OF THE INVENTION

The present invention relates to processes for making models and in particular processes for making models of very small things and very large things.

### BACKGROUND OF THE INVENTION

### Search for the Truth

Since the beginning of human civilization mankind has searched for explanations of the origin of our Universe, how it was put together and how it works. Early explanations involved supernatural beings and religions evolved from these efforts. More recent explanations have involved complicated mathematical explanations based on experimental evidence, some involving multiple extra dimensions. Many millions of dollars are being spent in the United States alone and similar efforts are underway in other countries in search of the ultimate tiny building blocks of our Universe and a process for explaining all of nature.

### Accepted Scientific Beliefs about Our Universe

### Popular Scientific Models

Popular scientific models propose a complicated set of elementary particles that are supposed to be building blocks of matter. These include electrons (positive and negative) and six types of quarks (three of which make a proton and three of which make a neutron) and neutrinos. Neutrinos are supposed to be produced in the sun, have the same spin as the electron, travel at, or very close to, the speed of light and most of them that illuminate the earth, according to accepted theories, pass right through it. Scientists do not have a good explanation of the internal structure of the electron or the proton. They are not able to isolate any of the six quarks or prove they exist. Scientists have detected flashes of energy in underground tanks that they attribute to neutrinos but there is no good proof that neutrinos exist. Scientist still cannot decide whether light is particles or waves.

These popular models also include a complicated set of forces. These include electromagnetic forces (that combines Coulomb electric forces with magnetic forces), the “strong” force holding atomic nuclei together, a “weak” force related to beta particle decay and the force of gravity. Prior art models include a spectrum of electromagnetic radiation, including cosmic rays, gamma rays, x-rays ultraviolet light, visible light, infrared light, millimeter waves, microwaves and radio waves. These models include the photon which is supposed to be a quantum of electromagnetic radiation having some features of a particle. Relativity theories attempt to model the effects of traveling at speeds close to the speed of light and to describe gravitational effects. Some of the results of relativity theories seem inconsistent with common sense and simple logic.

### Our Universe is Very Large

The earth and its sun are part of the Milky Way Galaxy. The Milky Way is an average size galaxy that has in it about 100 billion stars. (Our sun is one of those stars.) There are in our Universe more than 80 billion galaxies. This means there are more than (80×10⁹ galaxies)×(100×10⁹ stars/galaxy)=8×10²¹ stars in our Universe. That is 8 trillion billion stars. Many if not almost all of these stars are believed to have planets orbiting them and many if not most of these planets are likely to have moons. The distance to the edge of the observable universe is about 10²⁶ meters. That is 100 trillion-trillion meters. We know that our Universe is a very big place with lots of stuff in it, but scientists do not have a good explanation of how it was created or what ultimately is going to happen to it.

### The Birth of Our Universe

### The Big Bang

We also know that our Universe is currently expanding with the distances between galaxies (or clusters of galaxies) expanding faster depending on how far away the galaxies (or clusters) are from each other. We estimate the age of our Universe by dividing the distance to each galaxy by the speed at which the galaxy is moving away from our galaxy, the Milky Way. We get roughly the same answer for each galaxy for which we have a good estimate of distance. Based on these measurements and calculations scientists believe that our Universe originated about to 13 to 15 billion years ago in a Big Bang explosion. About 300,000 years after the Big Bang a very large number of small atoms formed, mostly hydrogen atoms and a much smaller number of helium atoms. Over time these atoms collected into gas clouds that later became stars. In the extreme heat in the core of stars hydrogen atoms combined to produce helium, and hydrogen and helium combined to produce larger atoms and these larger atoms combine with other atoms to make even larger atoms. Stars collected into galaxies. Some exploded sending the heavier atoms spreading out into interstellar space.

Planets, including our earth, formed from collections of the atomic debris of exploded stars. Some planets are mostly hot gases but scientists believe there are many planets with conditions similar to conditions on earth that are capable of supporting the development of life.

### Little Things are Still not Described

We know a lot about our Universe but scientists after centuries of scientific progress still do not have a good understanding of what goes on at sub-atomic levels or a good description of sub-atomic things such as electrons, protons and photons. We utilize electricity and magnetism every day but we do not have a good understanding of what electricity and magnetism really are. Scientists also do not have a good understanding of the force (the “strong” force) holding atomic nuclei together or the “weak” force involved in a type of nuclear decay. They know a lot about the Coulomb force. This is a force between electric charges that is repulsive for like charges and attractive for unlike charges. The force gets greater as the charges get closer together, which means for two like charges touching each other the repulsive force should be infinite. But scientist still cannot explain why the electron with a single charge and a size greater than zero does not blow itself apart with an infinite repulsive force. And they do not know how the forces of nature relate to each other.

### Big Things are Still not Understood

Scientists know that close-by galaxies are attracting each other and far-away galaxies are receding from each other, but they do not know why. Scientists tell us that our Universe began in a Big Bang about 13 to 15 billion years ago but there is no agreement as to what preceded the Big Bang. Scientists do not know whether our Universe will continue to expand forever or if it will at some time begin to contract. There is no answer to the question of whether our Universe is finite or infinite, or if it is finite what forms the boundary of our Universe.

### Atoms

There are 92 types of naturally occurring atoms, each with a nucleus and a unique number of orbiting electrons. Atoms each have a single relatively heavy positively charged nucleus and the nucleus is surrounded by one or more electrons, each of which has a negative charge of −e. The number of orbiting electrons in a charge neutral atom represents the atomic number of the atom. Some of the more familiar atoms are listed below:

TABLE I
Typical Atoms

| Number of Electrons | | |
|---|---|---|
| In Orbit | Atom | Symbol |
| 1 | Hydrogen | H |
| 2 | Helium | He |
| 6 | Carbon | C |
| 7 | Nitrogen | N |
| 8 | Oxygen | O |
| 10 | Neon | Ne |
| 11 | Sodium | Na |
| 12 | Magnesium | Mg |
| 13 | Aluminum | Al |
| 14 | Silicon | Si |
| 16 | Sulfur | S |
| 18 | Argon | Ar |
| 20 | Calcium | Ca |
| 26 | Iron | Fe |
| 29 | Copper | Cu |
| 47 | Silver | Ag |
| 79 | Gold | Au |
| 82 | Lead | Pb |
| 92 | Uranium | U |

The net charge of the nucleus of each neutral atom is equal and opposite the total charge of the number of electrons in orbit around the nucleus. So for example the net charge on the helium nucleus is +2e and the net charge of its two orbiting electrons is −2e. The net charge of the helium atom is 0 (since +2e added to −2e=0).

### Electrons

There are two types of electrons: (1) the type most people are familiar with that has a negative charge of −e (its official name is “negatron” but it is usually referred to as an “electron”) and (2) the type most people are not familiar with that has a positive charge of +e. It is called a “positron”. The positron is the anti-particle of the negative electron. This anti-particle is exactly like the negative electron except for its positive charge of +e. Pairs of electrons (one negatron and one positron) can be produced when high-energy photons (called gamma rays or gamma ray photons) interact with matter. When an electron and a positron combine they both vanish and are replaced by high-energy photons. These processes are respectively called “pair production” and “electron-positron annihilation”.

### Photons

Visible light is a part of an electromagnetic spectrum which (with decreasing energy) includes gamma rays, x-rays, ultraviolet light, visible light, infrared light, microwaves and radio waves. For more than 100 years scientists have known that the energy of the electromagnetic spectrum is “quantized”; which means light (and other forms of electromagnetic energy) comes in separate and distinct “quantities” of energy. These separate and distinct quantities of energy are called photons. Scientists do not know what a photon is or what it looks like but they do know that each photon carries a quantum of energy. Photon energy is usually expressed in joules (J), newton-meters (Nm) or electron volts (eV). The energy of a photon can be calculated from its wavelength λ using the following formula:

Eₚₕₒₜₒₙ=hc/λ, (1)

Where h is Planck's constant=6.626×10⁻³⁴ Nms=6.626×10⁻³⁴ Js=4.135×10⁻¹⁵ eVs. N is the symbol for newtons, m is meters eV is electron-volts and s is seconds. A newton-meter, a Nm is the same as a joule, J. The symbol c is the speed of light, c=˜3×10⁸ m/s, and λ is the wavelength of the photon, so for example:

Eₚₕₒₜₒₙ=hc/λ=(6.626×10³⁴ Nms)×(3×10⁸ m/s)/λ=1.99×10⁻²⁵ Nm²/λ or 1.99×10⁻²⁵ Jm/λ

For example the wavelength of a green light photon is 5.4×10⁻⁷ m, so the energy of this green light photon is:

E=(1.99×10⁻²⁵ Jm)/(5.4×10⁻⁷ m)=0.36×10⁻¹⁸ J

Readers should note that the smaller the wavelength of the photon the larger is its energy. Radio wave photons have relatively long wavelengths and gamma ray photons have relatively short wavelengths. Visible light photons are somewhere in the middle.

### Mass, Energy Conversion Units and Universal Constants

Existing reference books contain precisely measured values of the masses of atoms and sub-atomic particles and their equivalent energy (based on Albert Einstein's famous formula, E=mc²), and provide precise values of important conversion units and universal constants such as the electron charge and the vacuum speed of light.

Some of these values needed to understand the Ross Model are listed in Tables II, III and IV. To follow some of the math in the following section, readers may want to refer from time to time to the values in these tables. For now many readers will find the tables complicated. For those that do, I suggest you simply skip to the next section.

TABLE II
Masses of Some Small Atoms and Particles

| | | Mass | Energy |
|---|---|---|---|
| Particle or Atom | Symbol | (kg) | (MeV) |
| Electron at rest | e− | 9.109 3897 × 10⁻³¹ | 0.510 712 57 |
| Positron at rest | e+ | 9.109 3897 × 10⁻³¹ | 0.510 712 57 |
| Proton | p | 1.672 6231 × 10⁻²⁷ | 938.272 338 |
| Neutron | n | 1.674 9286 × 10⁻²⁷ | 939.565 628 |
| Deuteron | d | 3.343 5860 × 10⁻²⁷ | 1875.613 39 |
| Tritium isotope | ³H | 5.008 2711 × 10⁻²⁷ | 2807.857 70 |
| Hydrogen one atom | ¹H | 1.673 5340 × 10⁻²⁷ | 938.256 992 |
| Helium 4 atom | ⁴He | 6.646 4835 × 10⁻²⁷ | 3726.311922 |

TABLE III
Some Important Conversion Units

| | | |
|---|---|---|
| One electron volt | eV = 1.602 177 33 × 10⁻¹⁹ J | joules |
| | eV = 1.783 662 70 × 10⁻³⁶ kg | kilograms |
| | eV = 96.49 kJ/mole | kilo-joules per mol |
| One atomic mass unit | amu = 1.660 5402 × 10⁻²⁷ kg | kilograms |
| | amu = 932.0 MeV | million electron-volts |
| One kilogram | kg = 8.987551787 × 10¹⁶ J | joules |
| Joule (energy) | J = kgm²/s² | kilogram meter squared per second squared |
| Newton (force) | N = kgm/s² | kilogram meter per second squared |

TABLE IV
Universal Constants

| | | |
|---|---|---|
| Speed of light in vacuum | c = 2.99 792 458 × 10⁸ m/s | meters per second |
| Planks constant | h = 6.626 0755 × 10⁻³⁴ Js | joule-second |
| | h = 4.135 6692 × 10⁻¹⁵ eVs | electron-volt seconds |
| Avogadro constant | N_{A} = 6.022 1367 × 10²³/mole | per mole |
| Coulomb constant | k = 8.99 × 10⁹ Nm²/C² | newton meter²/coulomb² |
| Pi | π = 3.1416 | |
| Electron Charge | | |
| Elementary charge | e = 1.602 177 33 × 10⁻¹⁹ C | coulombs |
| Ampere | Amp = 1 C/s | coulomb per second |
| | Amp = 6.24 × 10¹⁸ e/s | electrons/second |
| Wein's Law | λ = 2.898 × 10⁻³ mK/T | |
| | E = 6.86 × 10⁻²³ J-T/K = 4.28 × 10⁻⁴ eV-T/K | |

where
λ is the peak wavelength of radiation emitted from a black body at temperature T in degrees Kelvin (K).
E is energy of radiated photons.
J is joules and
eV is electron-volts which are energy units.

The electrical force (also called the “Coulomb Force”) F, between stationary charged particles is:

F=kQᵢQ₂/r², (2)

where k=8.99×10⁹ N-m²/C², Q¹ and Q₂ are the charges in coulombs of the particles and r is the distance between the particles.

Avogadro's constant from Table IV represents the number of atoms of a particular material in a number of grams equal to the atomic mass number of the material. Pi (π) from Table IV is the ratio of the circumference of a circle to the circle's diameter. Plank's constant from Table IV gives us the energy of a photon using equation (1) if we know its wavelength.

TABLE V
Very Big and Very Small Numbers
If we are going to talk about galaxies and the internal structure of
protons, we will be dealing with a very wide range of numbers and
values. Scientist and engineers have developed a trick for doing
this using the number 10 and an exponent. I will give you some
simple examples:

Big and Bigger
10⁰ = 1 = one
10¹ = 10 = ten
10² = 10 × 10 = 100 = one hundred
10³ = 10 × 10 × 10 = 1,000 = one thousand
10⁴ = 10 × 10 × 10 × 10 = 10,000 = ten thousand
10⁶ = one million
10⁹ = one billion
10¹² = one trillion
10¹⁵ = one thousand trillion
10¹⁸ = one million trillion
Small and Smaller
10⁰ = 1 = one
10⁻¹ = 1/10 = 0.1 = one tenth
10⁻² = 1/(10 × 10) = 1/100 = 0.01 = one hundredth
10⁻³ = 10/(10 × 10 × 10) = 1/000 = 0.001 = one thousandth
10⁻⁴ = 10/(10 × 10 × 10 × 10) = 1/0000 = 0.0001 = one ten thousandth
10⁻⁶ = one millionth
10⁻⁹ = one billionth
10⁻¹² = one trillionth
10⁻¹⁵ = one thousand trillionth
10⁻¹⁸ = one million trillionth

### Need for a Simpler Process Describing Our Universe

Stephen Hawking in his book, The Theory of Everything, complained that science had become too complicated for philosophers and that they had ceased asking questions such as: “Did the universe have a beginning?” and he concluded his text as follows: “However, if we discover a complete theory, it should in time be understandable in broad principal by everyone, not just a few scientists. Then we shall all be able to take part in the discussion of why the universe exists. If we find the answer to that, it would be the ultimate triumph of human reason. For then we would know the mind of God.”

### SUMMARY OF THE INVENTION

The Ross Model is a process for modeling everything in our Universe. According to the Ross Model everything in our Universe is made from point particles called tronnies each of which has no mass and no volume and a charge of plus e or minus e. Each tronnie is self propelled by its own coulomb force at the speeds equal to the speed of light or greater. (A charge of e is the electron charge, about 1.602×10⁻¹⁹ coulombs.) An electron is made from one plus tronnie and two minus tronnies. A positron is made from one minus tronnie and two plus tronnies. Naked electrons and naked positrons have masses of about 0.00091×10⁻²⁷ kg and are self-propelled at speeds of 2.18×10⁶ m/s.

The energy quantum of our Universe is the entron, each of which is comprised of one plus tronnie and one minus tronnie circling each other at speeds of 1.57 times the speed of light. Energetic electrons are naked electrons that have captured at least one entron which provides the electron with its electrical energy. Each photon is comprised of one entron. The neutrino entron has a mass of about 1.65×10⁻²⁷ kg and energy of 928 MeV.

A proton is comprised of an energetic electron that has captured a neutrino entron and two naked positrons. Naked protons are self-propelled at speeds of 4×10⁷ m/s and collect gamma ray entrons to slow down enough to collect an electron to become hydrogen atoms. Some of these entrons are released when hydrogen is fused to make helium in hydrogen bomb explosions and in fusion reactions in stars.

Gravity is carried by neutrino photons which are produced in Black Holes at the center of galaxies by the destruction of protons. Each proton destroyed releases one neutrino entron many of which travel out from the Black Holes as neutrino photons at the speed of light. Neutrino entrons have a diameter of only 0.933×10⁻¹⁸ m and most pass through stars, planets and moons applying a reverse force as they pass through. A small percentage is temporarily stopped and later released in random directions giving stars, planets and moons their gravity. Low energy photons pass through interstellar space more efficiently than neutrino photons and apply a repulsive force on objects in far-away galaxies. Neutrino photons apply a stronger attractive force on nearby galaxies.

Our Universe is surrounded by a cold plasma shell of mostly electrons and positrons that reflect light from the galaxies in our Universe. The gravity producing neutrino photons from the 100 billion galaxies in our Universe that make it to the shell are captured by electrons and these electrons capture two positrons to form protons at the edge of our Universe. These protons slow down by capturing gamma ray entrons to become hydrogen atoms to help provide matter for star formation at the outer regions of our Universe. Everything in our Universe including photons are comprised of tronnies. These tronnies are spread throughout our Universe and each of them continually produces Coulomb force waves that spread out from each tronnie at the speed of light. These speed-of-light force waves produce Coulombic grids through which light travels. These grids each traveling at the speed of light also provides the points of Coulombic charge that are the tronnies that our Universe is made of.

Table VI provides some specific values describing features of the Ross Model to which the reader may need to refer as he proceeds through the following text.

TABLE VI
Ross Model Values

Entrons and Photons:
Ratio photon diameter d to entron diameter d′: d/d′ = 911
Photon wavelength λ: λ = 1431d′ = 1.5708d
Photon energy E: E = 1.389 × 10⁻²⁸ Jm/d′ = 8.67 × 10⁻¹⁰ eVm/d′
Electrons:
Mass of naked electron me: me = 9.109 × 10⁻³¹ kg
Velocity of naked electrons v: v = 2.18 × 10⁶ m/s
Kinetic energy of naked electrons KE: KE = 2.16 × 10⁻¹⁸ J = 13.5 eV
Protons:
Mass of naked proton plus one naked electron m:
m = 0.99883825 amu = 1.658611 × 10⁻²⁷ kg
Velocity of naked proton v: v = 4.02 × 10⁷ m/s
Neutrino photon and neutrino entron:
Wavelength λ: λ = 1.336 × 10⁻¹⁵ m
Diameter neutrino photon d: d = 0.85 × 10⁻¹⁵ m
Diameter neutrino entron d′: d′ = 0.933 × 10⁻¹⁸ m
Energy neutrino photon and neutrino entron E: E = 928 MeV =
1.487 × 10⁻¹⁰ J
Energy neutrino photon and neutrino entron m: m = 1.65 × 10⁻²⁷ kg

### BRIEF DESCRIPTION OF THE DRAWINGS

FIG. 1 is a graphical model of a tronnie.

FIG. 2A is a graphical model of an entron showing integrated forces on its tronnies.

FIG. 2B is another graphical model of an entron demonstrating why it is so stable.

FIG. 2C is a graphical model of a portion of a photon showing the path of its entron and tronnies.

FIG. 2D is similar to FIG. 2C but also shows Coulomb force waves.

FIG. 3 is a graphical model of a photon viewed from a frame traveling with the photon.

FIG. 4 is a graphical model of a photon viewed from a frame stationary with respect to the photon.

FIG. 4A is a graphical model of a neutrino photon demonstrating the force of gravity applied by the neutrino photon on a charged particle.

FIG. 5 is a graphical model of a naked electron.

FIG. 6 is a graphical model of an energetic electron.

FIG. 7 is a graphical model of a naked proton.

FIG. 8A is a first graphical model of a neutron.

FIG. 8B is a second graphical model of a neutron.

FIG. 9 is a graphical model of a deuteron.

FIG. 10 is a graphical model of a tritium nucleus.

FIG. 11 is a graphical model of an alpha particle.

FIG. 12 is a graph showing electron and proton velocity as a function of the energy of its captured entron.

FIG. 13 is a graphical model of out Universe and its cold plasma shell.

### DETAILED DESCRIPTION OF PREFERRED EMBODIMENTS

### The Tronnie

The Ross Model is based on the existence of a previously unknown point particle (which I discovered about six years ago and call the “tronnie”) from which everything in our Universe is made. Tronnies have no mass and no volume but they do have a charge of plus e or minus e. (A charge of minus e is the charge of an electron and a charge of plus e is the charge of a proton or the charge of the positron, which is as explained above the anti-particle of the electron.) By reason of their charges, tronnies carry the Coulomb force which expands out from each tronnie at the speed of light (3×10⁸ m/s) repelling like tronnies and attracting unlike tronnies. Each tronnie, being exactly like itself and having no mass, repels itself with its own Coulomb force, so each tronnie is always traveling at the speed of light or faster, never less than the speed of light! Each tronnie having no mass and no volume and a charge of exactly plus or minus e, is in effect one half of nothing. There are an equal number of plus tronnies and minus tronnies in our Universe, each one being one half of nothing, so in effect our Universe is made from nothing. This gives us a sense of how our Universe was created (or evolved) from nothing (empty space).

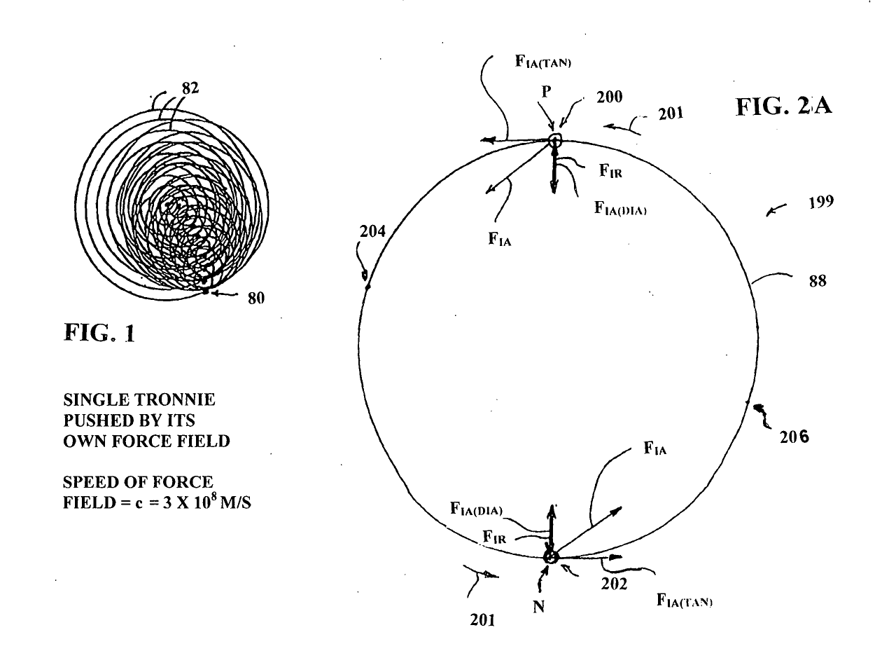

FIG. 1 is a drawing of a tronnie 80 being pushed along faster than the speed of light by its own Coulomb force waves 82 continuously expanding out from the tronnie at the speed of light as the tronnie itself is flying through space at the speed of light or faster. (The Coulomb force waves always travel at the speed of light. Tronnies travel at the speed of light only if they are going in a straight line and faster than the speed of light if their path is curved.

A single tronnie combines with another tronnie in a circling pair to form an “entron”, or with two other tronnies in a circling triplet to form an electron or a positron. Electrons are comprised of one plus tronnie and two minus tronnies, and positrons are comprised of one minus tronnie and two plus tronnies. An entron traveling at the speed of light is a photon. Below I describe in detail entrons, photons, electrons and positrons. Entrons, electrons and positrons are made from tronnies and everything else in our Universe is made from entrons, electrons and positrons.

### The Entron

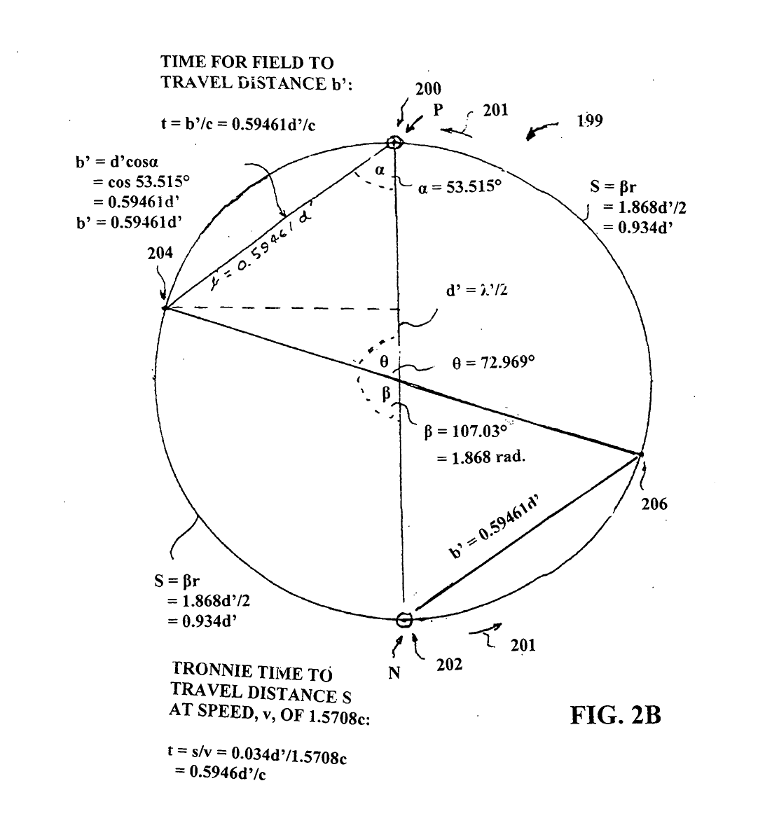

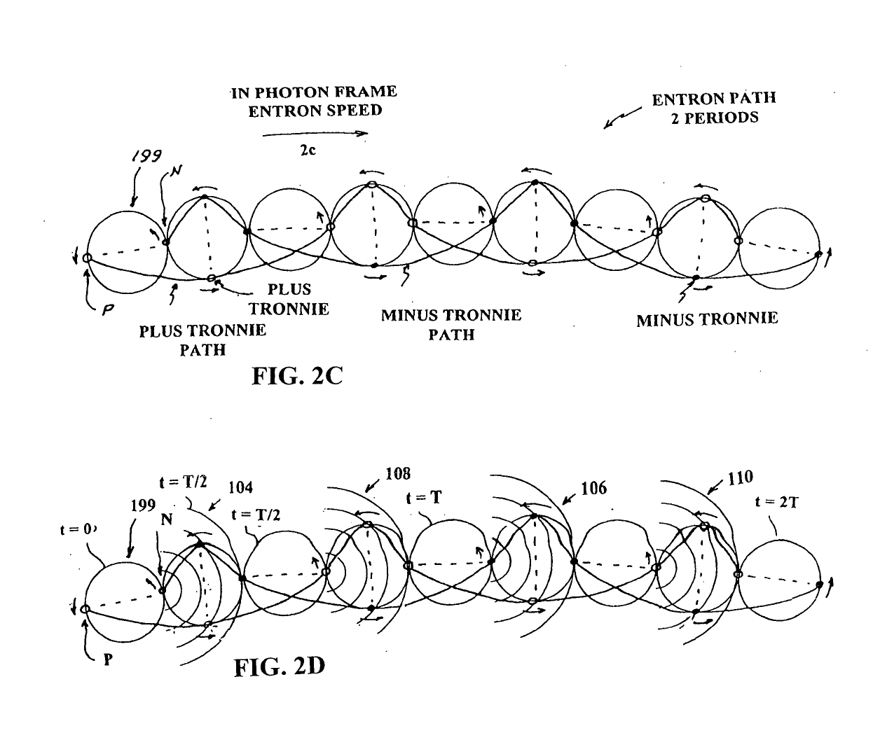

The two tronnies of the entron travel on opposite sides of a circle at a speed of 1.57c (π/2 times the speed of light). The diameter of the circle may be any size from 0.933×10⁻¹⁸ m to a few centimeters. The largest entrons are about 10 million billion times larger than the smallest entron. And the mass and energy of the smallest entrons are about 10 million billion times more massive and more energetic than the largest entrons. Otherwise all entrons are exactly alike as pictured in FIG. 2A. Although tronnies are point charges with no size, no mass and no energy, when a tronnie combines with another oppositely charged tronnie to form an entron, all of a sudden the pair has a size, energy and mass. However, the pair of tronnies (the entron) has no net charge. Do entrons have mass? I should say they do! Entrons represent almost all of the mass of our Universe!

These simple entrons also provide all of the energy of every photon. In fact they represent all of the energy in our Universe. They provide the heat and temperature of everything in our Universe. These entrons along with electrons and positrons are the building blocks of atoms which in turn are the building blocks of everything else. Except for a relatively very small mass contribution from electrons and positrons, entrons supply all of the mass of our Universe. A special entron carries the gravity of our Universe.

Entrons like tronnies were discovered by me and are a product of the Ross Model. The Coulomb force waves of each of the two tronnies travel diametrically, a distance d′, across the entron circle at the speed of light (c) while the tronnies themselves take a 1.57d′ longer half-circle route on the circumference of the circle at a speed of 1.57c so each of the two tronnies are continuously being repelled by their own Coulomb force waves with a force of F_{IR} coming diametrically from the opposite side of the circle (e.g. from point 202 to point 200 and from point 200 to point 202 as shown in FIG. 2A). Each of the two tronnies are also being attracted by Coulomb force waves from their partners F_{IA}, but these attractive force waves travel a shorter distance (e.g. from point 204 to point 200 and from point 206 to 202); so the F_{IA} attractive forces are stronger forces than the F_{IR} repulsive forces as indicated by the lengths of the arrows. (F_{IR} stands for integrated Coulomb repulsive force and F_{IA} stands for integrated Coulomb attractive force. These Coulomb forces when integrated around a circle are inversely proportional to the distance [not the square of the distance] the forces have to travel.)

The secret of the entron's success is that the component of the attractive integrated force F_{IA} in the diametrical direction F_{IA(DIA)} is exactly equal to the repulsive integrated force F_{IR} as shown by the drawing. The component of the attractive integrated forces in the tangential direction F_{IA(TAN)} is not cancelled and this force assures that the two tronnies will continue circling along their circumferential path. FIG. 2B provides some hints for readers who may want to check my trigonometry. The energies of the entrons and their masses are inversely proportional to their diameters d′ which, as explained above, can be any length from about 0.933×10⁻¹⁸ m to at least few centimeters. I have provided some detailed calculations of these integrated forces in a following section discussing the neutrino entron and the neutrino photon.

### Ross Model Photons

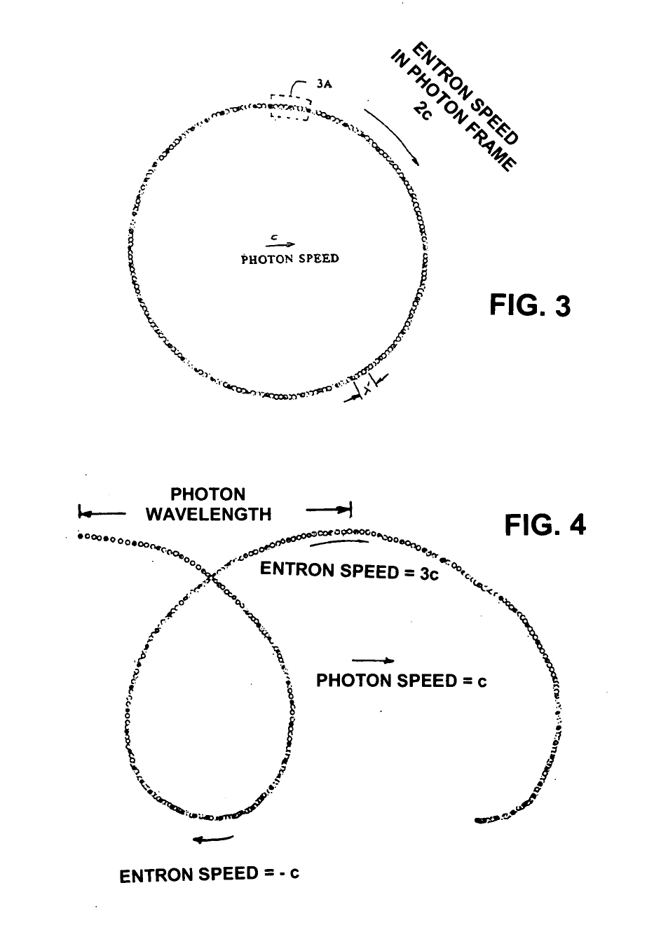

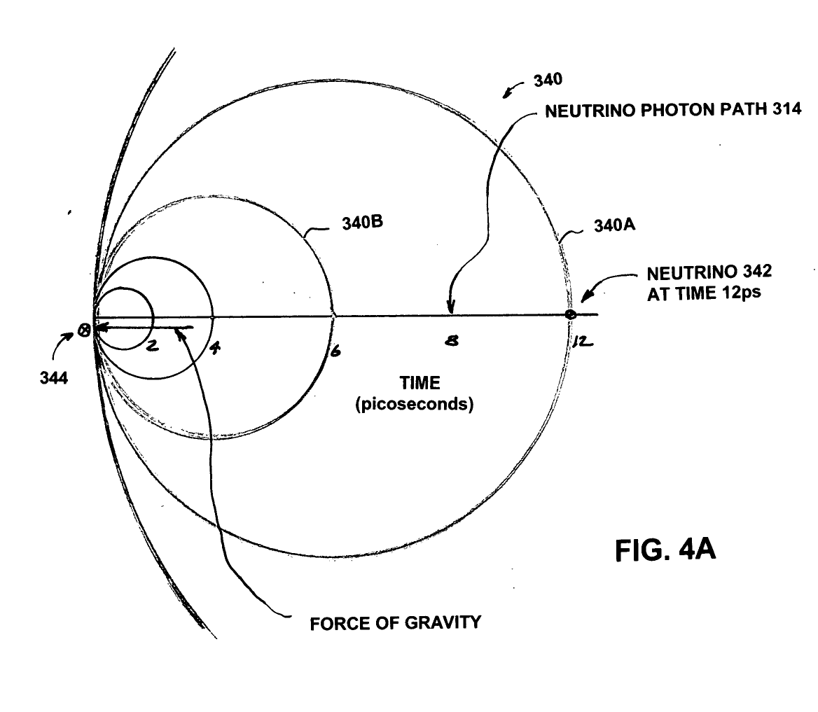

According to the Ross Model each photon is an entron traveling in a circle at a speed of 2c (twice the speed of light) as shown in FIG. 3 and forward at a speed of c (the speed of light) as shown in FIG. 4. FIGS. 2C and 2D show 2¼ cycles of an entron traveling within a photon. In the entron frame of reference (moving at a speed of 2c) each of the two tronnies in the entron are pushed by a Coulomb force coming from itself (at a speed c) diametrically across the circle from itself and is being attracted by an equal diametrical force from its partner as explained above with a reference to FIGS. 2A and 2B.)

The diameter d of the photon's circle is related to the photon's wavelength by the following formula:

d=0.6366λ. (4)

This relationship result from the fact that the time for the entron to travel around the circle, a distance of and at a speed of 2c is the same as the time for the entron to travel forward a distance equal to the photon wavelength λ at a speed of c. Time t=distance divided by speed, so:

t=λd/2c=λ/c,

therefore the diameter d of the photon is:

d=2λ/π=0.6366λ

The Ross Model proposes that there is also a precise relationship between the size of the entron circle as shown in FIGS. 2A and 2B and the size of its corresponding photon circle as shown in FIG. 3. I am not certain of the precise ratio d/d′ (where d′ is the diameter of the entron, but I am fairly certain that it is in the range of about 1,000 and that the ratio, once we know it with precision, is the same ratio for every entron-photon combination in our Universe. In a later section with certain assumptions I have calculated the ratio for the neutrino entron-neutrino photon combination and that calculation indicates that the ratio, d/d′≈911 and since the photon wavelength λ is equal to d/0.6366, this means the ratio λ/d′=1,431d′. (These numbers represent a change from my entron description in the parent application Ser. No. 12/455,989. There λ/d′ was estimated to be 911.6.) As indicated by FIGS. 2C and 2D the entron makes a complete cycle in a distance equal to four times its diameter in its looping photon path. This would mean (if all of my assumptions are correct that the entron makes about 1,431 d′/4d′=357.75 cycles in one photon circle and one photon wavelength. There are 360 degrees in every circle. Therefore the numbers that I will use for d/d′ and λ/d′ and the entron cycles per photon cycle or period are as follows:

d/d′=911 (5)

λ/d′=1,431 (6)

entron cycles/photon period=about 360 (7)

There is substantial support in experimental evidence of my estimate of about 1,000 for the ration of d to d′. We know that gamma rays (with wavelengths λ in the range of about 10⁻¹² m) are released from the nuclei of atoms which have sizes in the range of about 10⁻¹⁵ m. We also know that ultra-violet photons with wavelengths of about 10⁻⁷ m are released from atoms which have sizes of about 10⁻¹⁰ m. I am hopeful of confirming my current estimate of 1,440 as the correct ratio (or at least that it is close to correct) but after about three years of worrying with this issue, I have not yet confirmed it. So I will continue to use 1,440 until I or someone else develops a better number. If a better number is found, it will be easy to make the appropriate adjustments to the Ross Model.)

TABLE V
Typical Photons

| | Photon-Entron | Photon | Entron | |
|---|---|---|---|---|
| | Energy | Wavelength | Diameter | Temperature |
| Photon | (eV) | (m) | (m) | (K) |
| Radio Wave Photons | 1 × 10⁻⁸ | 1.24 | 8.67 × 10⁻² | 2.34 × 10⁻⁴ |
| Microwave Photons | 1.02 × 10⁻⁵ | 1.21 × 10⁻¹ | 8.5 × 10⁻⁵ | 0.024 |
| Millimeter Wave Photons | 3.07 × 10⁻⁴ | 4.0 × 10⁻³ | 2.8 × 10⁻⁶ | 0.717 |
| Near Infrared Photon | 0.124 | 1.0 × 10⁻⁵ | 6.94 × 10⁻⁹ | 290 |
| Human Body Temperature | 0.267 | 9.89 × 10⁻⁶ | 6.09 × 10⁻⁹ | 310 |
| Visible Light Photons-Green | 2.29 | 5.4 × 10⁻⁷ | 3.77 × 10⁻¹⁰ | 5,350 |
| Sun Surface Temperature | 5.00 | 2.48 × 10⁻⁷ | 1.7 × 10⁻¹⁰ | 5,778 |
| Ultraviolet Light Photons | 13.5 | 9.18 × 10⁻⁸ | 6.40 × 10⁻¹¹ | 3.15 × 10⁴ |
| X-Ray Photons | 12.4 × 10³ | 1.0 × 10⁻¹⁰ | 6.99 × 10⁻¹⁴ | 2.90 × 10⁷ |
| Gamma Ray Photon | 7.47 × 10⁵ | 1.66 × 10⁻¹² | 1.16 × 10⁻¹⁵ | 1.73 × 10⁹ |
| Pair Production Gamma Ray | 1.02 × 10⁶ | 1.22 × 10⁻¹² | 8.5 × 10⁻¹⁶ | 2.38 × 10⁹ |
| Gamma Ray Photon | 8.37 × 10⁶ | 1.48 × 10⁻¹³ | 1.03 × 10⁻¹⁶ | 1.95 × 10¹⁰ |
| Neutrino Photon | 9.28 × 10⁸ | 1.34 × 10⁻¹⁵ | 0.934 × 10⁻¹⁸ | 2.16 × 10¹² |

Once entrons which have been trapped in matter are released from the matter the electric forces expanding out from the two tronnies making up the entron force the entron into the complicated path shown in FIG. 4. The entron itself keeps its circular configuration. However, both tronnies in the entron are attempting to stay ahead of their own Coulomb force waves as the tronnies are leap-frogging each other as shown in FIGS. 2C and 2D. This results in the entron being propelled at twice the speed of light (2c=6×10⁸ m/s) as shown in FIG. 2C. The entron does not travel in a straight line at a speed of 2c. Since the Coulomb force waves from each of the two tronnies is traveling at a speed of c (c=3×10⁸ m/s), over any distance that is large compared to the diameter of the entron, the entron wants to travel at a speed of c, otherwise it would quickly outrun its own Coulomb force waves. How can the entron travel at a speed of 2c and also travel at a speed of c? Easy, it just travels in a circle at a speed of 2c as shown in FIG. 3 defining a photon circle and the circle travels at a speed of c. The net effect is shown in FIG. 4.

Albert Einstein in developing his special theory of relativity wondered what a photon would look like if he could have caught up with it and observed it. He did not follow up on his question possibility because he erroneously concluded that nothing with mass could go as fast as a photon, i.e. at the speed of light. If he had followed up on his question he might have concluded that the photon in its own frame of reference would look like FIG. 3. He might have also correctly concluded that the entron goes faster than the speed of light (up to three times the speed of light, see FIG. 4).

With the entron circling at a speed of two times the speed of light and proceeding in a forward direction at the speed of light (c=3×10⁸ m/s); the entron path looks like the drawing in FIG. 4. This path looks somewhat like the path that a small light would describe if it were mounted on the rim of a wagon wheel rolling across the prairie at night. The perfect analogy would be a light on the rim of circular frame where the light on the rim is traveling at twice the speed of the wagon instead of only 1.57 times the speed of the wagon which is the normal speed of a point on the rim. Remember, the two tronnies of the entron are continuing to travel in their own circle which has a diameter that is about 911 times smaller than the diameter of the photon circle.

From the view of a stationary person watching the photon pass by the entron actually travels backwards at a speed equal to the speed of light at one point during each cycle of the photon as shown in FIG. 4. Its fastest speed is 3c and its average speed in the direction of the photon travel is c, all as shown in FIG. 4.

When entrons radiate away from matter in the form of photons the wavelength of the photon is determined by the energy of the photon which is the same as the energy of the entron. This relationship between photon energy and wavelength has been known for more than 100 years and is described by equation (1) (i.e. E=hc/λ). Substituting values for h and c from Table IV,

Eₚ=19.864×10⁻²⁶ Jm/λ

As explained above, the photon's wavelength λ is determined by the diameter d′ of its entron. The equation explaining this relationship as explained above is:

λ=1431d′

where λ is the photon wavelength and d′ is the entron diameter. Therefore:

Eₚ=1.39×10⁻²⁸ Jm/d′

The energy of the photon Eₚ is the same as the energy of its entron Eₑ, so the energy of the entron Eₑ is also:

Eₑ=1.39×10⁻²⁸ Jm/d′

When photons are absorbed in matter (such as in the body of a pretty girl lying half-naked on the beach soaking up the photons from the sun) the entrons that were the energy and mass of the photons then become integral parts of her body. When she is lying on the beach in the sunlight, she is absorbing visible, ultraviolet and infrared photons and her warm body is radiating mostly infrared photons and millimeter wave photons. Most of the photons absorbed by her body are absorbed as heat energy warming up her body. Photons radiating out from her body carry heat energy out of her body. Much of the visible light from the sun reflects off her body and bathing suit allowing people to see her and her bathing suit. Entrons in matter may exist in the form of heat energy increasing the temperature of the matter or it could be absorbed chemically and become a part of a new molecule in the matter. For example some of the ultraviolet light absorbed in her skin is used by her skin cells to produce vitamin D. Entrons of sunlight photons absorbed in leaves of plants are used (along with carbon dioxide in the air, water atoms and molecules from the soil) by the plants to produce organic molecules allowing the plant to grow. Each of those entrons carries a small amount of energy. When a person consumes portions of the plant directly (such as when she eats a lettuce leaf or a carrot) or indirectly (such as when she drinks a glass of milk) those entrons become available to provide energy for her legs to propel her across a tennis court, a soccer field or a golf course.

### The Neutrino Entron and the Neutrino Photon

The most energetic entrons and the most important entrons in our Universe are the “neutrino entrons” (each with a diameter d′ₙₑ which I estimate to be about 0.933×10⁻¹⁸ m (a distance that is about 100 million times smaller than the size of a typical atom). Its corresponding photon, the neutrino photon is also the most important photon in Our Universe. Its wavelength λₙₑ is estimated at 1.336×10⁻¹⁵ m and the circle of this photon has a diameter of 0.85×10⁻¹⁵ m. The neutrino entron and the neutrino photon each has a mass of about 1.6546×10⁻²⁷ kg and an energy of about 1.487×10⁻¹⁰ J or about 928×10⁶ eV). Later on in a section entitled “Mass and Energy of the Neutrino Entron” I will explain how I estimated these values. One of these neutrino entrons, captured by a naked electron, is located in each proton and provides the proton with almost all of its mass. Similarly, one of these neutrino entrons, captured by a naked positron, is located in each anti-proton and provides the anti-proton with almost all of its mass. Anti-protons are extremely rare in most parts of our Universe but they are very abundant in Black Holes and in the shell surrounding our Universe. Protons and anti-protons are destroyed in the Black Hole by their combination which annihilates both the proton and the anti-proton and release two neutrino entrons as “neutrino photons”. Many of these neutrino photons escape from the Black Holes to provide the gravity of their galaxies. So neutrino entrons (one in each neutrino photon) are the carriers of gravity as will be explained in detail later on. Neutrino entrons in the neutrino photons are also the “dark matter” or our Universe providing the great majority of the mass in our Universe. Dark matter will also be described later on.

A neutrino entron combines with a gamma ray entron and a low-energy entron in the formation of each electron-positron pair in a process called “pair production”. In this process the neutrino entron disappears. However, a new neutrino entron is produced and released in a subsequent process called “electron-positron annihilation” when the positron produced in the pair production process quickly combines with an electron. Pair production and electron-positron annihilation will also be discussed in more detail later on. Neutrino entrons have an estimated diameter of 0.9325×10⁻¹⁸ m as explained above, so we can calculate the forces on the two circling tronnies that constitute a neutrino entron. If you will refer to FIG. 2B and equation (2), you will see that tronnie P is constantly subjected to a repulsive Coulomb force coming from itself across the diameter of the circle. According to Coulomb's Law if these two charges were stationary the repulsive force would be equal to:

F=kQ₁Q₂/r²

Where k is 8.99×10⁹ Nm²C², Q1 and Q2 are each equal to 1.602×10⁻¹⁹ C, and r is the diameter of the neutrino entron's circle, 0.933×10⁻¹⁸ m. If you do the math you will see that the repulsive force on tronnie P would be about 265 million newtons if the two charges were stationary. This would be a tremendous force, attempting to push the tiny entron apart, equivalent to about 29,000 tons. The attractive force holding the neutrino entron together would be much greater since the distance between the tronnie N (when its Coulomb force wave left it in the direction to intercept tronnie P) and tronnie P is only b=0.59461d′ or 0.5548×10⁻¹⁸ m so the attractive force (assuming again that the charges were stationary) would be approximately 765 million newtons or about 85,000 tons. However the charges are not stationary by a long shot. They are circling at 1.57 times the speed of light. So what we need to do is to integrate the forces around the respective circles defined by the distances traveled by the Coulomb forces between each tronnie and itself (200 to 202) and between each tronnie and the other tronnie (204 and 200 and 206 and 202).

When these forces are integrated for one cycle (around the circumference of a circle with diameter equal to the distances traveled by the coulomb force) the integrated forces are:

$$\begin{matrix}F = {\int }_{0}^{C} \frac{{kQ}_{1} {Q}_{2}}{{r}^{2}} d C = {kQ}_{1} {Q}_{2} {\int }_{0}^{C} \frac{d C}{{( C / π )}^{2}} \\ = {π}^{2} {kQ}_{1} {Q}_{2} {\int }_{0}^{C} {C}^{- 2} d C = {π}^{2} {kQ}_{1} {Q}_{2} / C = π {kQ}_{1} {Q}_{2} / r\end{matrix}$$

where C in this case is the circumference of the circle. So the integrated force is:

F=πkQ₁Q₂/r,

and the integrated forces are now inversely proportional to the distance between the charges (i.e. the diameter of the entron circle) instead of being inversely proportional to the square of the distances between the charges and the integrated forces have units of energy (joules or electron volts) instead of newtons. The repulsive integrated forces in the diametrical direction are equal to about 7.769×10⁻¹⁰ joules (4.9×10⁹ eV). The attractive integrated forces are equal to about 1.32×10⁻⁹ joules (8.25×10⁹ eV); however, the attractive integrated forces in the diametrical direction are this force decreased by the cosine of 53.515 degrees which is 0.5946. So the attractive integrated forces in the diametrical direction are (0.5946)×(1.32×10⁻⁹ joules)=0.785×10⁻⁹ joules which is exactly equal to the integrated repulsive forces in the diametrical direction. The attractive integrated forces in the tangential directions are 1.32×10⁻⁹ joules multiplied by the sine of 53.515 degrees (i.e. 0.804) which product is about 1.06×10⁻⁹ joules. Since everything in this entron is in perfect dynamic balance, the neutrino entron is an extremely stable particle. We will have much more to say about the neutrino entron as we proceed with our description of the Ross Model. This particular entron is the thing that is responsible, along with the little tronnies it is made of, for the existence of our Universe!

### Electrons and Positrons

### Naked Electrons

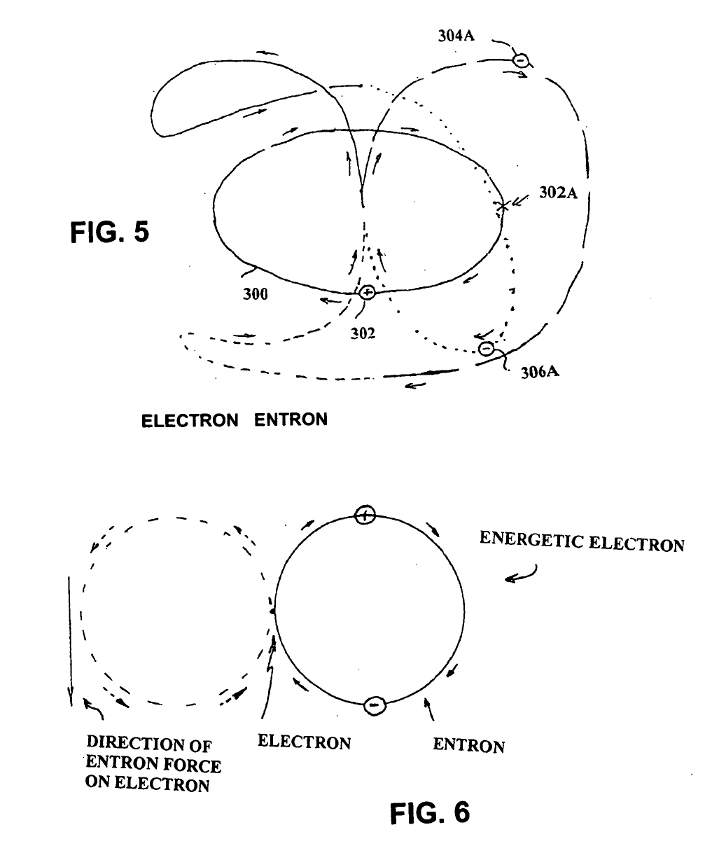

The Ross Model describes the internal structure of electrons in their ground or zero voltage state. I call the ground state electrons “naked electrons” because they unlike energetic electrons are not “wearing” excess energy in the form of entrons. FIG. 5 is a snap shot drawing of a naked electron. Naked electrons are comprised of one plus tronnie shown as a plus signal 302, traveling in a circle 300 with a diameter of 0.933×10⁻¹⁸ m at a speed of 1.57c. The time for the electron to complete one cycle is about 0.622×10⁻²⁶ second. The electron's frequency is about 1.6×10²⁶ cycles per second (more than 1.6 hundred billion-billion cycles per second). And the two minus tronnies each shown as a minus at 304A and 306A circling the path of the plus tronnie in circles of the same diameter and frequency. At the instant of the FIG. 5 snap shot drawing, the two circling minus tronnies are circling around location 302A on circle 300, one-fourth period behind the plus tronnie which is as shown in FIG. 5 now located at location 302. The reader should recognize here that the naked electron is extremely small with a complicated shape that would fit in a box with sides of 2×10⁻¹⁸ m. Except for tronnies (which has no size at all) and neutrino entrons, with dimensions about one half the size of electrons, the naked electron and its anti-particle the naked positron are the smallest things in our Universe. Typical atoms are about 100 million times larger than naked electrons and positrons. Naked electrons and naked positrons are self-propelled. Note that in the drawing of the naked electron, both of the minus tronnies pass upward through the center of circle 300 at the rate of 1.6×10²⁶ passes per second. On each pass through the center at speeds faster than the speed of light, Coulomb force waves from the two minus tronnies attract the plus tronnie in an upward direction giving the naked electron a natural velocity. According to the Ross Model that natural velocity is currently estimated to be 2.18×10⁶ m/s (2.18 million meters per second) a little less than one percent of the speed of light) giving the naked electron a kinetic energy (mv²/2) of 2.16×10⁻¹⁸ J (which is equivalent to 13.5 eV):

E=½mv²=½(9.102×10⁻³¹ kg)(2.18×10⁶ m/s)²=2.16×10⁻¹⁸ J

(I am fairly certain that naked electrons are self propelled, but I am not certain of the exact speed. For now I am estimating 2.18×10⁶ m/s.) So according to the Ross Model all of the orbital electrons in their ground state are naked electrons circling around atomic nuclei at 2.18×10⁶ m/s, a little less than one percent of the speed of light. According to the Ross Model every naked electron is traveling at its natural speed of 2.18×10⁶ m/s. This explains why zero energy (naked) electrons can remain in orbit around the positive nuclei of atoms without being drawn into the nucleus by attractive Coulomb forces. The natural velocity of the self-propelled naked electrons is also of great importance in the Ross Model description of magnetism and the cold plasma shell which contains our Universe as we will see later on in this paper.

Although, according to the Ross Model, naked electrons have a tremendous natural velocity, 2.18×10⁶ m/s (2.18 million meters per second), giving each electron a kinetic energy of 13.5 eV, the Ross Model proposes that the naked electron carries no electrical energy. The electrical energy of naked electrons is zero! This is an extremely important revelation of the Ross Model. Almost all electrons in orbit around the nuclei of atoms are naked electrons with no electrical energy. On the other hand conduction electrons are almost always energetic electrons and energetic electrons always carry electrical energy, as we will see in the next section. We will also discover in the section entitled “Magnetism” that the Ross Model proposes that magnetic fields are comprised of nothing but naked electrons.

### Energetic Electrons

Naked electrons can capture entrons to become “energetic electrons”. They are distinguished from naked electrons by reason of the fact that they are “wearing at least one entron. The Ross Model proposes two classes of energetic electrons, “low energy electrons” and “high energy electrons”. Entrons with entron energies less than the natural kinetic energy (less than 13.5 eV or 2.16×10⁻¹⁸ J) of the naked electrons slow the electrons down. I refer to these electrons, (i.e. electrons having captured an entron with energies less than 13.5 eV) as “low energy electrons”. FIG. 6A is a drawing of a low-energy electron. Its electrical energy is less than 13.5 eV and its kinetic energy is the difference between 13.5 eV and its electrical energy. An energetic entron with 13.5 eV of electrical energy has approximately zero kinetic energy. The entron has a diameter d′ of about 0.64×10⁻¹⁰ m. The entron is about one half the size of a typical atom and about 300 million times larger than the electron. Lower energy entrons have an even larger diameter. So the actual size of the electron is greatly exaggerated in FIG. 6A.

The two tronnies of the captured entron pass through the plus tronnie circle of the naked electron in the same direction as the minus tronnies of the naked electron. Once an entron is captured by a naked electron the entron becomes part of the electron and the electron becomes an energetic electron. The Coulomb forces of the captured entrons tend to push the energetic electron in a direction opposite the natural direction of the naked electron as shown in FIG. 6B. Low energy entrons slow down the naked electron from its natural velocity of 2.18×10⁶ m/s to zero for entron energies of 13.5 eV and high energy entrons (entron with energies greater than 13.5 eV) drive the energetic electron in a direction opposite the normal direction of the naked electron. An electron with a captured entron with energies greater than 13.5 eV is referred to in the Ross Model as a “high-energy electron”.

As explained above the frequency, energy and mass of the entron is inversely proportional to the entron's diameter. The captured entrons of both the low-energy electrons and the high-energy electron give naked electrons their electrical energy. For example all of the conduction electrons in a copper wire connected to the 6-volt battery will have electrical energy of about 6 eV (1.08×10⁻¹⁸ J) and a velocity that is very slightly lower than the velocity of the naked electron. On the other hand all of the orbital electrons in the copper wire will be in their “ground state”, would have captured no entrons and would carry zero electrical energy. Electricity will be explained in more detail later on.

Electrons, positrons, protons and alpha particles can be propelled at high energies to speeds close to the speed of light by captured high-energy entrons, in directions opposite their natural direction of travel. These high-energy entrons each has a mass that corresponds to their energy based on Albert Einstein's famous equation:

E=mc² (3)

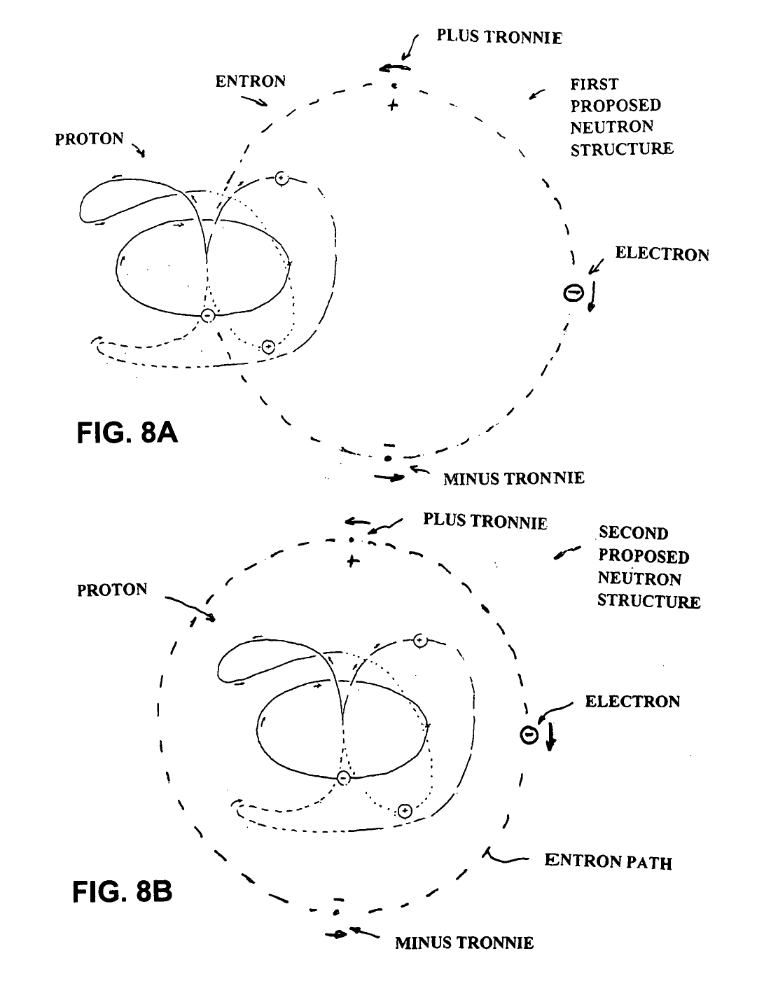

Particles that capture entrons are propelled by the captured entrons. The mass of the captured entrons add to the mass of the particles they are propelling. Therefore, the speed of high-speed particles can only be increased with a corresponding increase in the mass of the particles. This increase in mass with energy results in a limit on the speed of the energetic particles when the mass of the propelling entron becomes very large compared to the mass of the particle being propelled. In FIG. 8 for example I have plotted the speeds of the electron and the proton as a function of the energy (in joules) of its captured entron. When the entron energy is close to the natural kinetic energy of the particle, its speed approaches zero. Higher energy entrons result in increasing speed in the opposite directions. The net speed is determined by the well-known relationship:

$$E = ( 1 / 2 ) {mv}^{2} or$$

$$v = \sqrt{\frac{2 E}{m}}$$

But now the mass includes the mass of both the particle m_{N} and its captured entron mₑ and the energy E is the difference between the natural energy E_{N} and the energy of the entron Eₑ. Therefore, the velocity of the particle is determined by the following formula:

$$v = \sqrt{\frac{2 ( {E}_{N} - {E}_{e} )}{{m}_{N} + {m}_{e}}}$$

Each entron captured by an electron adds to the mass of the electron, however for low energy electrons the additional mass is insignificant. For example a 13.5 eV ultraviolet entron has a mass of only:

mₑ=(13.5 eV)(1.784×10⁻³⁶ kg/eV)=2.4×10⁻³⁵ kg

which is insignificant compared to the electron mass of 9.109×10⁻³¹ kg. However, high energy entrons can greatly increase the mass of electrons. For example a one million eV entron which would be an entron produced by a one million volt accelerating source would have a mass of:

mₑ=(1×10⁶ eV)(1.784×10⁻³⁶ kg/eV)=1.784×10⁻³⁰ kg.

This is an additional mass almost double the mass of the naked electron.

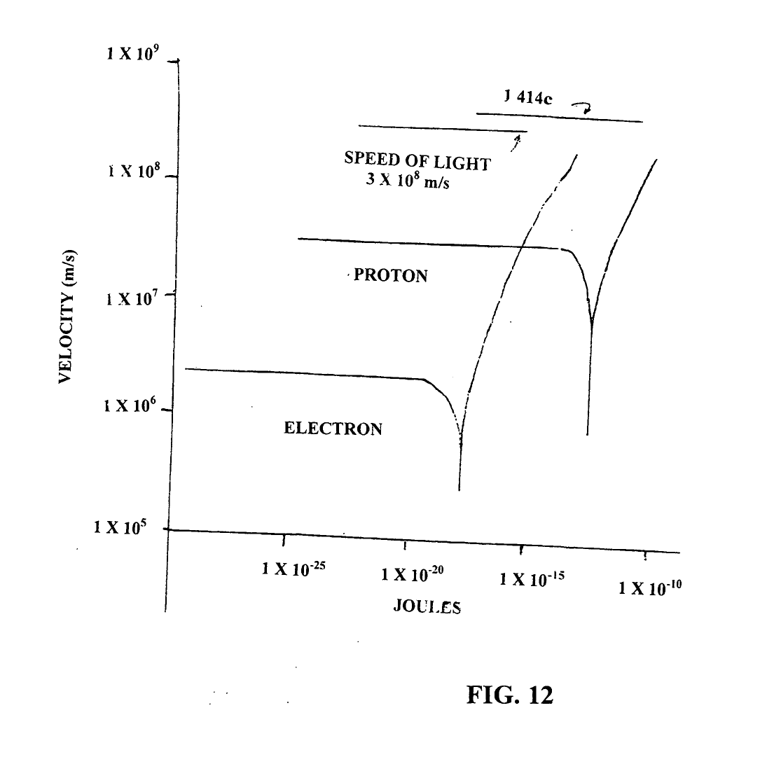

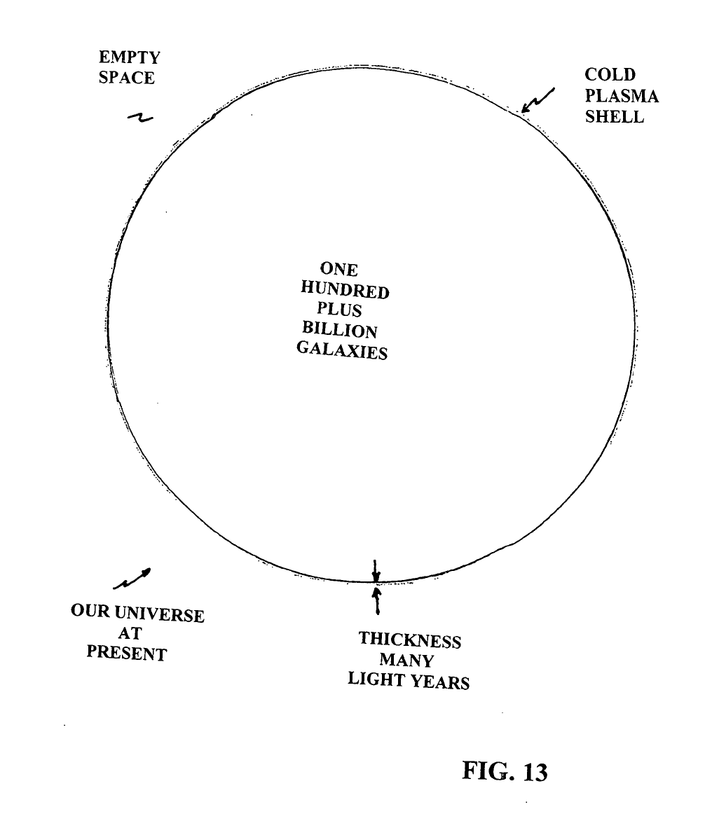

As a consequence, at entron energies in the range of about 13.5 eV to about 3 KeV electron velocities increase fairly linearly with increasing entron energies but above a few MeV the velocity tends to level off as shown in FIG. 12 as the velocity of the electron approaches the speed of light. Also at very high entron energies the diameter of the entron approaches the size of the electron and instead of the electron following a linear path, the path it follows is a circular path. We will have more to say about very high energy electron speeds and paths later on.

### Positrons

Positrons, naked and energetic (as in prior art models) are the anti-particle of electrons and naked positrons are also self-propelled at the same speed of 2.18×10⁶ m/s. A drawing of a naked positron would be exactly like the FIG. 5 drawing except the center tronnie is a minus tronnie and the two tronnies circling the center tronnie are plus tronnies.

### Protons

According to the Ross Model there are, like electrons, two types of protons, “naked protons” and “energetic protons”. An energetic proton is a naked proton that has captured at least one entron.

### The Creation of Naked Protons

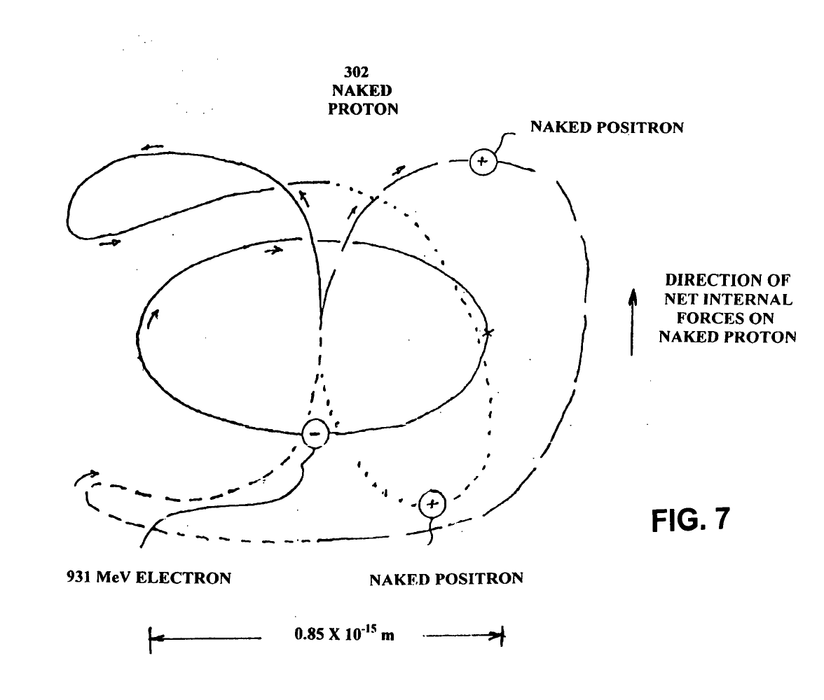

According to the Ross Model each naked proton is comprised of two naked positrons (each with a tiny mass of 9.109×10⁻³¹ kg), one naked electron (with a mass of 9.109×10⁻³¹ kg) which has captured a neutrino entron (with a mass of about 1.65497×10⁻²⁷ kg, more than a thousand times greater) to form a very energetic and very massive electron traveling at a speed of 1.57 times the speed of light. According to the Ross Model the frequency of the neutrino entron is the same as that for the electron, and the neutrino entron is about one-half the size of the naked electron (i.e. 0.933×10⁻¹⁸ m); so in the very unlikely event that they resonately intersect with each other traveling at similar speeds, there is a good chance that the neutrino entron will be captured by the electron. When that happens, the entron becomes a part of the electron and increases the electron's velocity to a speed greater than the speed of light (1.414c as explained in more detail below). However, instead of driving the electron in a straight line as might be expected, the entron drives the electron in the neutrino photon's circle (see FIG. 3) which, as explained above, is a circle with a diameter of 0.6366λ where λ is the wavelength of the neutrino photon. The wavelength of the neutrino photon is about 1.33×10⁻¹⁵ meters, so the diameter of the circle of the electron and its captured neutrino entron is about 0.85×10⁻¹⁵ meters. If there are positrons in the vicinity of the rapidly spinning electron, they will be attracted to the center of the electron's circle and begin circling behind the energetic electron as shown in FIG. 7. The very energetic negative electron circling in a tiny circle of 0.9325×10⁻¹⁸ m at 1.414c will exert a Coulombic force on itself across the diameter of the circle and this additional repulsive force will boost the speed of the very energetic electron to 1.57c in order to add to the stability of the proton. If one positron attempts to combine with the spinning electron the combination will be unstable; however, two positrons in combination with the spinning neutrino-entron-energized electron form the most stable composite particle in our Universe (i.e. the naked proton). According to the Ross Model the naked proton once created cannot be destroyed except by the combination of it with its anti-particle, the anti-proton.

The two naked positrons each with a mass of only 9.109×10⁻³¹ kg are circling the path of the very energetic electron at one-fourth period behind the electron. The diameter of the circle of each of the naked positrons is also 0.85×10⁻¹⁵ m to give the naked proton a size of about 1.7×10⁻¹⁵ m. Naked protons are self-propelled by internal Coulomb forces at an estimated velocity of 4×10⁷ m/s which is a little faster than 10 percent of the speed of light. These naked protons collect gamma ray entrons to slow down to speeds close to zero in the same way electrons collect low energy entrons to slow down as explained above. As will be explained in detail later in this paper, this creation of protons from the combination of an electron, two positrons and a neutrino entron is not currently happening on any significant scale, in the part of our Universe that is visible to us. This is because there are not many positrons available in the portion of our Universe that is visible to us. (The reader should keep in mind that we cannot see what is going on inside of Black Holes or at the Shell of our Universe.) In the very early seconds of after the Big Bang there were just about as many positrons as there were electrons and a tremendous flux of neutrino photons. So soon after the Big Bang enough protons were mass produced by the combination of massive electrons and two naked positrons to create the early phase of our Universe. As we will see later on more of our Universe is currently being created within the shell of our Universe. Also in Black Holes huge numbers of anti-protons are currently being created inside Black Holes and as each anti-proton combines with a proton, both are destroyed. But we will get to Black Holes, the formation of our Universe and its shell later in this paper. FIG. 7 is a drawing showing the structure of the naked proton. Its structure is similar to the structure of the naked electron, but much larger. The circles of the two positrons have diameters equal to 0.85×10⁻¹⁵ meters, the same as the very energetic electron, which gives the proton a size of about 1.67×10⁻¹⁵ meters. The spin of the proton is the same as the spin of the electron, but the proton is about 1800 times more massive than the electron and about 580 times larger than the electron.

### Proton's Natural Velocity

The Ross Model assumes that the naked proton has a natural velocity, like the naked electron that is a fraction of the speed of light but the naked proton's speed is much faster than the speed of the naked electron. That speed is so fast that the naked proton cannot capture an electron to become a hydrogen atom. The naked proton must first capture gamma ray entrons to slow down. To estimate the energy/mass of these gamma ray entrons needed by the naked proton to slow down to zero, the Ross Model compares the iron-56 atom to the most abundant hydrogen atom, hydrogen-1 which is comprised of one proton, one orbiting electron and, according to the Ross Model, several gamma ray entrons circling through its nucleus. The Ross Model assumes that the proton of the hydrogen-1 atom has captured entrons having sufficient total energy to slow the proton down to a speed close to zero. The question is: what is the mass and energy of these entrons?

The Ross Model assumes that the nucleus of all stable neutral atoms (other than hydrogen-1 and possibly iron-56) are comprised of only naked protons, naked electrons and entrons in their nuclei with a number of orbiting electrons all or nearly all of which are naked electrons. (Hydrogen-1 has no electrons in its nucleus and iron 56 may not have any entrons in its nucleus. We are not counting the electron, two positrons and the neutrino entron that are part of each naked proton.) The number of electrons in the nucleus is equal to the difference between the number of protons in the nucleus and the number of electrons orbiting the nucleus. (The Ross Model does not include neutrons in the nuclei of atoms.) The hydrogen-1 atom (with one naked proton and an unknown number of captured entrons in the nucleus and one naked electron in orbit) has a mass of about 1.007828 atomic mass units (amu). An amu is equal to 1.66054×10⁻²⁷ kg. So the mass of the hydrogen-1 atoms in kilogram units is about 1.673538×10⁻²⁷ kg. The iron-56 isotope has the smallest mass-to-atomic number ratio of any stable isotope. The mass of the iron-56 isotope is about 55.934942 amu. Its atomic number is 56. The Ross Model assumes that the iron-56 atom is comprised of 56 naked protons and 56 naked electrons (30 of which are in the nucleus and 26 are orbiting) and no entrons (or only entrons with insignificant mass/energy) within or outside the nucleus. With these assumptions the mass of one naked proton and one naked electron has a mass no greater than: 0.99883825 amu, i.e.:

55.934942 amu/56=0.99883825 amu=1.658611×10⁻²⁷ kg

The difference in mass between the hydrogen 1 atom and the combination of one naked proton and one naked electron must be equal to the mass of the entrons in the hydrogen 1 nucleus. This leads in the Ross Model to an estimate that the entrons in the nucleus of the hydrogen atom have a mass equal to or greater than 0.00899 amu (i.e. 1.007828 amu minus 0.998838 amu). The difference 0.00898 amu is equal to 0.0149×10⁻²⁷ kg. (The mass of the entrons could be greater than 0.0149×10⁻²⁷ kg if the iron-56 nucleus contains one or more entrons with a total entron mass that is significant compared to 0.0149×10⁻²⁷ kg.) The energy equivalent to this entron mass of 0.0149×10⁻²⁷ kg is about 1.34×10⁻¹² J (equivalent to 8.37 MeV). A single entron with this energy would have a wavelength of:

λ=hc/E=(6.626×10⁻³⁴ Js)(3×10⁸ m/s)/1.34×10⁻¹² J)=1.483×10⁻¹³ m

According to the Ross Model as will be explained above, the diameter of an entron is related by the following formula to the wavelength of a photon that be formed by the entron:

d′=λ/1431.

So the diameter of a single entron with an energy of 8.37 MeV would be:

d′=1.483×10⁻¹³ m/1431=1.036×10⁻¹⁶ m.

This diameter appears too small relative to the diameter of the circle of the very energetic electron in the naked proton which is 8.4954×10⁻¹⁶ m. Therefore, this preferred embodiment of the Ross Model proposes that the naked proton is slowed down to near zero speed with the capture of several entrons (probability about 10 to 20) with energies in the gamma ray range. The total energy of all of these entrons is estimated to be about 1.34×10⁻¹² J (8.37 MeV). For example, if the number of entrons is 10 each with about the same energy the diameters of these ten entrons would be about 1×10⁻¹⁵ m (a little larger than the diameter of the 931 MeV electron in the proton (see FIG. 7). If there are 20 approximately equal entrons slowing down the naked proton, their diameters would be about 2×10⁻¹⁵ m. These diameters are larger than the naked proton but much smaller than the orbits of the orbiting electrons which is about 1×10⁻¹⁰ m.

So now let us get back to estimating the natural, self-propulsion speed of the naked proton. This self-propulsion of the naked proton is due to the net Coulomb force applied by the two positrons in the naked proton as each of them pass upward through the center of the proton's high-energy electron's circle. According to the Ross Model that force applied twice during each of the proton's 1.786×10²³ cycles per second, is sufficient to provide the naked proton with a natural velocity which is estimated using the equation:

E=½mv²

where E is the total energy of the entrons needed to cancel the naked proton's natural kinetic energy. As explained above the Ross Model estimates the energy of the entrons needed to slow down the naked proton to about zero speed from 8.37 MeV which is equivalent to 1.341×10⁻¹² J. The estimated mass of the naked proton is 1.6586×10⁻²⁷ kg, so the Ross Model's estimate of the natural velocity of the naked proton is:

$$v = \sqrt{\frac{2 E}{{m}_{H}}} = \sqrt{\frac{2 ( 1.341 \times {10}^{- 12} J )}{1.6596 \times {10}^{- 27} kg}} = 4.02 \times {10}^{- 7} m \text{/} s$$

which is a little faster than one-tenth of the speed of light.

The velocity of a hydrogen nuclei, with 8.37 MeV of captured entron energy (also equal to 1.341×10⁻¹² J), is approximately zero. Entrons with energies greater than 8.37 MeV will propel the proton in directions opposite the naked proton's natural direction as explained above with respect to the electron. However, the higher entron energies mean larger entron masses which increase the mass of the proton. When the entron mass/energy becomes large compared to the mass of the naked proton the proton's speed levels off at 1.414c as in the case of the energetic electron. The result is that the maximum velocity of a proton propelled with entron energy is the same as the maximum velocity of electrons propelled with entron energies, i.e. 1.414c. FIG. 8 is a graph of electron and proton velocities as a function of captured entron energies. The formula is the same as Equation (8) except E_{N} is the natural energy of the naked proton and m_{N} is the mass of the naked proton.

The zero energy (naked) electron mass is assumed to be approximately the same as published values of mass of the electron at rest, i.e. 9.1094×10⁻³¹ kg as explained above. The zero energy (naked) proton mass is determined by assuming that the iron 56 isotope is comprised of 56 protons with no captured entrons and 56 electrons with no captured entrons. (The reader should understand that when I am referring to zero energy/mass, I am referring to zero electrical energy contributed by captured entrons. In this context the zero energy particles (naked particles) have very significant kinetic energy, due to their self-propelled velocity, but no entron energy, i.e. no electrical energy.) We will learn later on that the energy of entrons captured by electrons or an ion (the naked proton is an ion) is equivalent to electrical energy on an atomic scale. Entron masses, energetic electron masses and energetic proton masses are shown in Table VI for entron energies from zero joules to 1.487×10⁻¹⁰ joules. Table VII provides energetic electron and proton energies and energetic electron velocities for the same range of entron energies. Table VII indicates that it should be easy to accelerate electrons to speeds greater than the speed of light (3×10⁸ m/s) but it may not be possible to accelerate protons as fast as the speed of light. This is because the most energetic entron in our Universe is the neutrino entron with an energy of 1.487×10⁻¹⁰ joules.

TABLE VI
Energetic Electrons and Protons
Mass

| | | | Energetic | |
|---|---|---|---|---|
| Entron Energy | | Entron Mass | Electron | Energetic Proton |
| (Joules) | Entron Energy | (J/c²) | Mass | Mass |
| (kg-m²/s²) | (eV) | (kg) | (kg) | (kg) |
| zero | zero | zero | 9.1094 × 10⁻³¹ | 1.66 × 10⁻²⁷ |
| 1 × 10⁻³⁰ | 6.242 × 10⁻¹² | 1.1126 × 10⁻⁴⁷ | 9.1094 × 10⁻³¹ | 1.66 × 10⁻²⁷ |
| 1 × 10⁻²⁷ | 6.242 × 10⁻⁹ | 1.1126 × 10⁻⁴⁴ | 9.1094 × 10⁻³¹ | 1.66 × 10⁻²⁷ |
| 1 × 10⁻²⁴ | 6.242 × 10⁻⁶ | 1.1126 × 10⁻⁴¹ | 9.1094 × 10⁻³¹ | 1.66 × 10⁻²⁷ |
| 1 × 10⁻²¹ | 6.242 × 10⁻³ | 1.1126 × 10⁻³⁸ | 9.1094 × 10⁻³¹ | 1.66 × 10⁻²⁷ |
| 1 × 10⁻¹⁸ | 6.242 × 10⁰ | 1.1126 × 10⁻³⁵ | 9.1095 × 10⁻³¹ | 1.66 × 10⁻²⁷ |
| 1 × 10⁻¹⁵ | 6.242 × 10³ | 1.1126 × 10⁻³² | 9.2207 × 10⁻³¹ | 1.66 × 10⁻²⁷ |
| 1 × 10⁻¹² | 6.242 × 10⁶ | 1.1126 × 10⁻²⁹ | 1.2026 × 10⁻²⁹ | 1.68 × 10⁻²⁷ |
| 1.492 × 10⁻¹⁰ | 9.31 × 10⁸ | 1.655 × 10⁻²⁷ | 1.655 × 10⁻²⁷ | 3.32 × 10⁻²⁷ |

TABLE VII
Energetic Electrons and Protons
Energy and Velocity

| Entron | | | Energetic | |
|---|---|---|---|---|
| Energy | Energetic | Energetic | Electron | Energetic Proton |
| (J) | Electron Energy | Proton Energy | Velocity | Velocity |
| (kg-m²/s²) | (J) | (J) | (m/s) | (m/s) |
| zero | 2.16 × 10⁻¹⁸ | 1.34 × 10⁻¹² | +2.18 × 10⁶ | +4.02 × 10⁷ |
| 1 × 10⁻³⁰ | 2.16 × 10⁻¹⁸ | 1.34 × 10⁻¹² | +2.18 × 10⁶ | +4.02 × 10⁷ |
| 1 × 10⁻²⁷ | 2.16 × 10⁻¹⁸ | 1.34 × 10⁻¹² | +2.18 × 10⁶ | +4.02 × 10⁷ |
| 1 × 10⁻²⁴ | 2.16 × 10⁻¹⁸ | 1.34 × 10⁻¹² | +2.18 × 10⁶ | +4.02 × 10⁷ |
| 1 × 10⁻²¹ | 2.16 × 10⁻¹⁸ | 1.34 × 10⁻¹² | +2.18 × 10⁶ | +4.02 × 10⁷ |
| 1 × 10⁻¹⁹ | 2.06 × 10⁻¹⁸ | 1.34 × 10⁻¹² | +2.13 × 10⁶ | +4.02 × 10⁷ |
| 1 × 10⁻¹⁸ | 1.06 × 10⁻¹⁸ | 1.34 × 10⁻¹² | +1.523 × 10⁶ | +4.02 × 10⁷ |
| 2.16 × 10⁻¹⁸ | zero | 1.34 × 10⁻¹² | zero | +4.02 × 10⁷ |
| 1 × 10⁻¹⁷ | 7.84 × 10⁻¹⁸ | 1.34 × 10⁻¹² | −3.423 × 10⁶ | +4.02 × 10⁷ |
| 1 × 10⁻¹⁶ | 9.8 × 10⁻¹⁷ | 1.34 × 10⁻¹² | −2.146 × 10⁷ | +4.02 × 10⁷ |
| 1 × 10⁻¹⁵ | −1 × 10⁻¹⁵ | 1.34 × 10⁻¹² | −4.658 × 10⁷ | +4.02 × 10⁷ |
| 1 × 10⁻¹³ | −1. × 10⁻¹³ | 1.34 × 10⁻¹² | −4.24 × 10⁸ | +2.73 × 10⁷ |
| 6.66 × 10⁻¹³ | −6.66 × 10⁻¹³ | zero | −4.24 × 10⁸ | zero |
| 1 × 10⁻¹² | −1 × 10⁻¹² | 0.34 × 10⁻¹² | −4.24 × 10⁸ | −2.02 × 10⁷ |
| 1.487 × 10⁻¹⁰ | 1.487 × 10⁻¹⁰ | 1.500 × 10⁻¹⁰ | −4.24 × 10⁸ | −2.98 × 10⁸ |

### Energetic Protons

Naked protons are slowed down with the capture of several entrons with energies totaling about 8.37 MeV to form the nucleus of a hydrogen atom. Some or all of these entrons are released as gamma ray photons in processes in which four naked protons and two electrons joined together in a fusion processes to form a naked alpha particle. These released entrons represent the heat/energy of the hydrogen bomb and the heat/energy of our sun and most of the stars.

### Mass and Energy of the Neutrino Entron

According to the Ross Model a naked proton is comprised of two naked positrons and one very energetic electron which is a naked electron that has captured a neutrino entron (or has been captured by a neutrino entron). Now we know from Table II that the combined mass of the naked electron and two naked positrons is 3×(0.00091094×10⁻²⁷ kg)=0.0027328×10⁻²⁷ kg. So we can estimate the mass of the neutrino entron if we know the mass of the naked proton.

From Table II we know that an ordinary proton (the nucleus of a hydrogen 1 atom) is approximately 1.67262×10⁻²⁷ kg. However, we also know that the ordinary proton is significantly more massive that a naked proton because energy is released when ordinary protons are combined to form helium and additional energy is released when the helium nuclei are combined to form even heavier atoms. In fact, energy is released in all combinations to form heavier atoms from the combination of lighter atoms until we get to iron 56. For atoms heavier than iron 56, energy has to be added to form the heavier atoms from lighter atoms. This version of the Ross Model assumes that the difference in mass between an ordinary proton and a naked proton is gamma ray entrons that have been captured by the naked proton to slow it down enough so it can capture an orbital electron to become hydrogen 1 atom. These captured gamma ray entrons are released in fusion processes when heavier atomic nuclei are formed from the lighter atomic nuclei.

As explained above, I have made the further assumption that iron-56 nuclei contain no significant mass of gamma ray entrons. My assumption therefore is that the iron 56 atom contains 56 naked protons and 30 naked electrons in its nucleus (to give the nucleus a positive charge of plus 26) and 26 naked electrons in orbit around the nucleus (to give the atom a net zero charge). We know that the iron-56 atom has a total mass of about 92.8822×10⁻²⁷ kg. This means that a single naked proton and one naked electron would have a mass of 1.65861×10⁻²⁷ kg. The naked electron has a mass of 0.00091044×10⁻²⁷ kg, so the mass of the naked proton is estimated to be: m=1.6576956×10⁻²⁷ kg.

Now we subtract the masses of the naked electron and two naked positrons from our estimate of the mass of the naked proton to obtain the mass of the neutrino entron:

m_{neutrino entron}=1.6576956×10⁻²⁷ kg−0.0027328×10⁻²⁷ kg=1.65496×10⁻²⁷ kg.

We get the energy of the neutrino entron using Professor Einstein's famous formula:

E=mc²

E_{neutrino entron}=(1.65496×10⁻²⁷ kg)(2.99792×108 m/s)²

E=1.48739×10⁻¹⁰ J

The energy in electron volts is:

E_{neutrino entron}=(1.48739×10⁻¹⁰ J)/1.602×10⁻¹⁹ J/eV=928×10⁶ eV=928 MeV=9.28×10⁸ eV

### More About Electrons, Neutrino Entrons and Neutrino Photons

The neutrino entron is the most massive entron in our Universe. It is also the smallest entron in our Universe. In fact, aside from tronnies that have no size at all, the neutrino entron is the smallest thing in our Universe. It is about one-half the size of a naked electron or a naked positron which are the second and third smallest things in the Universe (again excluding tronnies). Neutrino entrons are so small that nearly all of them in a beam of neutrino photons can pass through the earth, giant planets and stars at the speed of light with no problem. How small are neutrino entrons? Here is where we estimate the size of the neutrino entron.

Each neutrino entron, like all entrons, is comprised of one plus tronnie and one minus tronnie as indicated in FIG. 2A. Keep in mind that the neutrino entron has no thickness since the each of its two tronnies has no size, but the neutrino entron, like all entrons, does have a diameter and a circumference. We will define the size of our entrons by their diameter d′. Also keep in mind that photons, including neutrino photons also have a diameter as we have explained above and also no thickness. We will refer to the diameter of photons as d. So d′ is the diameter of a neutrino entron and d in the diameter of its corresponding neutrino photon. In this section we will calculate our estimate of the ratio of d to d′, i.e. the ratio of the neutrino photon diameter to the neutrino entron diameter. Once we have the ratio, we will use that ratio for all entrons and their respective photons.

### Diameter d of the Neutrino Photon

First we need to calculate the size, diameter d, of the neutrino photon. Since we have estimated the energy E of the neutrino entron as 9.28×10⁸ eV and since we assume that the energy of the neutrino photon is the same as the energy of its entron, we can calculate the wavelength λ and the diameter d of the neutrino photon using equations:

E=hc/λ

λ=hc/E and

d=0.6366λ.

From the above equations we see that:

λ_{neutrino photon}=(4.135×10⁻¹⁵ eVs)(2.9979×10⁸ m/s)/9.28×10⁸ eV=1.336×10⁻¹⁵ m

and that:

d_{neutrino photon}=(0.6366)1.336×10⁻¹⁵=0.85×10⁻¹⁵ m

### Diameter of the Neutrino Entron

To find the diameter of the neutrino entron, we assume (1) that the naked electron (see FIG. 5) has a definite size and frequency and (2) that the size of the naked electron depicted in FIG. 5 is determined by circle 300 of plus tronnie 302. The actual size of the naked electron is a fairly complicated thing as is clear from an observation of FIG. 5 in that the naked electron is comprised only of three tronnies that have no size at all. So the naked electron could be considered as being 100 percent empty space. Nevertheless we will give it a size as being defined by the paths made by its three constituent tronnies. The paths of the two minus tronnies are very complicated paths but the path of the plus tronnie is a simple circle. From FIG. 5 it is also clear that the distance separating the two minus tronnies is a distance equal to the diameter of the plus tronnie circle. That is why we say that the size of the electron is determined by the diameter of the path 300 of the plus tronnie 302. We will also define the size of the electron as about twice the size of the diameter of the path of tronnie 302.

We also assume that the neutrino entron has a diameter equal to the diameter of the circular path 300 of the plus tronnie 302 in each naked electron as shown in FIG. 5. The reader may think that this is a wild assumption; however, there are several good supports for this assumption, at least if the reader will accept some of the more general concepts of the Ross Model. For example the Ross Model predicts that magnet field of the earth is in reality naked electrons circulating through the earth and around it at the natural speed of the naked electron (2.18×10⁶ m/s) and that the gravitation of the earth toward the sun is produced by neutrino entrons from the sun that pass through the earth. This would indicate that the two particles may be of similar very small size. The Ross Model also assumes that the small percentage of neutrino entrons that are captured in the earth are resonately captured by naked electrons which suggests that the naked electrons and the neutrino entrons are the same size and function at the same frequency. In the next section we calculate the size (diameter) of the neutrino entron and the ratio of its diameter to the diameter of the neutrino photon. (This will become an important calculation because we will then use that ratio as our estimate of the ratio of the diameter of all entrons to the diameter of its corresponding photon.)

### The Diameter of the Neutrino Entron and the Ratio d/d′

The Ross Model description of pair production is one in which:
(1) the two tronnies of a neutrino entron,
(2) the two tronnies of a 1.02 MeV gamma ray entron and
(3) the two tronnies of a low energy entron;
   (totaling 3 plus tronnies and 3 minus tronnies) combine to form an electron and a positron (having a total of 3 plus tronnies and 3 minus tronnies).

We know that pair production takes place only when gamma radiation at energies equal to or greater than 1.02 MeV interacts with matter. We also know that a 1.02 MeV gamma ray photon has a wavelength λ=1.22×10⁻¹² m and that the size of electrons and positrons are about a million times smaller at about 2×10⁻¹⁸ m. The Ross Model assumes that a naked electron serves as a catalyst to bring together the three entrons needed for pair production and for the combination to take place, both 1.02 MeV gamma ray entrons and the neutrino entron must be in resonance with the naked electron. The energy E of the of the 1.02 MeV gamma ray in joules is 1.634×10⁻¹³ J. The wavelength of the 1.02 MeV gamma ray photon is λ=hc/E=1.22×10⁻¹² m. The diameter d of the 1.02 MeV gamma ray photon then is:

d_{GR Photon}=0.6366λ=(0.6366)(1.217×10⁻¹² m)=7.74×10⁻¹³ m.

We know that gamma ray photons including the 1.02 MeV gamma ray photon come from the nuclei of atoms which have diameters in the range of 10⁻¹⁵ m to 10⁻¹⁴ m, (i.e. much smaller than the wavelength and the diameter of the gamma ray photons). According to the Ross Model, this is possible because the thing that is a gamma ray photon on the outside of an atomic nuclei is a gamma ray entron on the inside of the nuclei. The question is, how much smaller is the diameter of the entron as compared to the diameter of the photon?

We know that the energy of the 1.02 MeV gamma ray photon is 1.02 MeV. We assume that this is also the energy of its entron. Now we have estimated according to the section entitled “Mass and Energy of the Neutrino Entron” that the energy of the neutrino entron is 928 MeV. This estimate was derived from our assumption that the naked proton is comprised of a naked electron, a neutrino entron and two naked positrons and that the neutrino entron provides all of the mass of a naked proton except for the mass of the electron and the two positrons. We have also assumed that the energy of each entron is inversely proportional to the diameter of the entron, and we have further assumed that the wavelength and the diameter of a photon is proportional to its entron's diameter. Now the question is how could both the gamma ray entron and the neutrino entron be resonate with the plus tronnie of a naked electron? The answer has been suggested above and the answer is that each entron defines two circles:
(1) the circle formed by its two tronnies defining a diameter d′ (see FIG. 2A) of the entron and
(2) the circle formed by the entron when it travels as a photon (see FIG. 3).

Therefore the Ross Model proposes that the neutrino photon is resonate with the naked electron because the diameter d′ of its entron and the frequency of its entron is equal to the diameter of the circle defined by path 300 of the plus tronnie in the naked electron and that neutrino entrons being resonant with naked electrons can be captured by naked electrons. The Ross Model also proposes that once a neutrino entron with a mass-energy equal to 1.654596×10⁻²⁷ kg (1.48739×10⁻¹⁰ J=928 MeV) is captured by an electron with a mass-energy of 0.00091×10⁻²⁷ kg (0.51 MeV), the electron is driven along the circular path of the neutrino entron in the neutrino photon with diameter d=0.85×10⁻¹⁵ m. Next we assume that the diameter of the 1.02 MeV gamma ray entron is equal to the diameter of the neutrino photon. We have calculated the diameter of the neutrino photon in the section entitled “Diameter of the Neutrino Photon” based on the estimate we made of the energy-mass of the neutrino photon which was based on our assumption that almost all of the mass of a naked proton is attributable to a neutrino entron captured by the naked electron in the naked proton. Our estimate of the diameter of the neutrino photon is d_{neutrino entron}=0.85×10⁻¹⁵ m. So our assumption is that the diameter d′ of the 1.02 MeV gamma ray entron is equal to:

d′_{1.02 MeV GR}=d_{neutrino entron}=0.85×10⁻¹⁵ m.

This gives us a ratio of the diameter d of the 1.02 MeV photon to the diameter d′ of its entron of:

d/d′=(7.74×10⁻¹³ m)/(0.85×10⁻¹⁵ m)=911 and

d=911d′.

Since λ=d/0.6366:

λ=1431d′

This ratio d′/d′=911 for the 1.02 MeV gamma ray entron is very important to the Ross Model since according to the model all entrons are exactly alike except for size, mass and energy, all of which define the electro-magnetic spectrum of about 16 orders of magnitude. So if we know d/d′ for one photon-entron combination, we know it for all photon-entron combinations. So let us apply this knowledge first to the neutrino photon-entron. Thus:

d′_{neutrino entron}=(d_{neutrino photon})/911=(0.85×10⁻¹⁵ m)/911=0.933×10⁻¹⁸ m.

So this is the diameter of a neutrino entron according to the Ross Model. If you want you can round this number off to d′=about 1×10⁻¹⁸ m to make it easier to remember.

### Size of the Electron

Based on the assumptions we were making in determining the size of the neutrino entron we can now estimate the size of the naked electron. Our assumption was that the diameter of the neutrino entron is equal to the diameter of the circular path 300 (see FIG. 5) of the plus tronnie in the naked electron. Based on this estimate the diameter of the plus tronnie's circle is:

Naked Electron's Plus Tronnie's Circle=0.933×10⁻¹⁸ m=about 1×10⁻¹⁸ m

The size of the electron (again see FIG. 5) is about twice the size of the plus tronnie's circle, so the size of the naked electron is about 2×10⁻¹⁸ m.

### The Nucleus of the Hydrogen Atom

According to existing theories the nucleus of the most abundant isotope of hydrogen, H¹, is merely a proton. The Ross Model differs slightly. According to the Ross Model the proton (at least the naked proton) is traveling too fast (i.e. 4.02×10⁷ m/s, more than 13 percent of the speed of light) to capture an orbital electron. A graphical model of the naked proton is shown in FIG. 7. In order to capture an orbital electron to become a hydrogen atom, the proton must slow down to a speed much closer to zero. The proton captures a sufficient number of entrons so that its entron energy equals about 8.37 MeV which slows the naked electron down to approximately zero velocity. A proposed model of the hydrogen-1 nucleus has six entrons with energies totaling 8.37 MeV circling through it to slow it down to close to zero speed. The diameter of the 8.37 MeV entron would be about 0.162×10⁻¹⁵ m, which is significantly smaller than the size of the naked proton so it could not serve as a brake to slow down the proton. However each of the six 1.395 MeV entrons with diameters of 9.754×10⁻¹⁶ m might combine to provide sufficient breaking force on the proton. Also twelve 0.6975 MeV entrons with diameters of 1.951×10⁻¹⁵ m. should also work.

### Neutrons

According to the Standard Model, the nuclei of all atoms except the most abundant hydrogen atom contains a number of neutrons that are about equal to, or somewhat more than, the number of protons in the nuclei. Two or three neutrons are released when an atom of uranium fissions during fission processes such as in an uncontrolled chain reaction (like an atomic bomb explosion) or in a controlled chain reaction (like inside a nuclear reactor). The chain reaction that keeps the reactor producing power depends on the control of the population of these neutrons. Neutrons are supposed to be very stable when inside most nuclei. Scientists know that neutrons are very unstable when outside atomic nuclei. They decay after a short lifetime, averaging about 15 minutes, into a proton and an electron and something else. Scientists think that something else is an old fashion neutrino.

According to the Standard Model a neutron is suppose to be made of quarks. A quark is supposed to have charges equal to a fraction of an electron charge. No one has ever detected a quark and no one has ever detected a charge smaller than the electron charge. Still scientists believe in quarks. As explained above, scientists have known for many years that the decay products of neutron decay are a proton and an electron. To me, it is almost beyond belief that the scientific community has not suspected that the neutron must be made of an electron and a proton.

The Ross Model proposes a new model of the neutron. According to the model the neutron is made of a naked proton and a naked electron (with a combined mass of 0.99883825 amu) and a number of entrons sufficient to provide the neutron with its measured mass of 1.00866492 amu. That difference is equivalent to 0.00982667 amu and 9.1585 MeV (see Table XII).

The parts (the electron, the naked proton and the high-energy entrons) exist inside the nuclei as separate components of the nuclei. The electron portion of the neutron has a negative charge and this negative charge is vital in the larger atom in applying its coulomb force to help hold the nuclei together.

Occasionally an electron and a proton will be ejected together from the nuclei as this unstable, short-lived package which scientists call a neutron. Neutrons ejected from nuclei are ejected with very high kinetic energy. In the fission process (in atomic bombs and nuclear reactors the velocities of these neutrons are about 2.8×10⁷ m/s (about 9 percent of the speed of light). They rightly are called “fast neutrons”. According to the Ross Model the estimated velocity of the naked proton is 4.0226×10⁷. According to the Ross Model naked neutrons like naked electrons and naked protons are self-propelled and like the naked electrons and protons, slow down by capturing high-energy entrons. In most nuclear reactors, water is provided to help slow down the neutrons. Scientists believe the neutron loses its kinetic energy by elastic collisions (similarly to billiard ball collisions) with the hydrogen nuclei in the water. According to the Ross Model the neutron does not lose its velocity by collisions it loses its natural self-propelled velocity by stealing entrons from hydrogen atoms and other atoms in its environment, and these stolen entrons once captured by the neutron reduce the natural speed of the neutron.

Often a neutron will be absorbed in the nuclei of another atom before it decays into a proton and an electron in which case the components of the neutron becomes a part of the absorbing nuclei. In many cases the nuclei absorbing the neutron will be radioactive as a result of the absorption and as a result will release an electron, a proton or an entron (in the form of a gamma ray photon) to return to a stable condition. This is further support for the Ross Model contention that a neutron is merely a combination of a proton, and electron and one or more entrons.

Outside the nucleus if the neutron is not absorbed quickly it will decay with an average lifetime of about 15 minutes. When the neutron decays after this brief lifetime, the decay products are the proton and an electron (referred to as a beta particle with an energy of 0.782 MeV or 1.253×10⁻¹³ J. According to the Ross Model this is the energy of the entron of the beta particle, Eₑ. If we use equation (8) and this energy of the electron we can estimate the velocity of the electron:

$$\begin{matrix}v = \sqrt{\frac{2 ( {E}_{N} - {E}_{e} )}{{m}_{N} + {m}_{e}}} \\ = \sqrt{\frac{2 ( 1.253 \times {10}^{- 13} J )}{9.109 \times {10}^{- 31} kg + 13.0 \times {10}^{- 31} kg}} \\ = \sqrt{10.89 \times {10}^{16}} \\ = 3.3 \times {10}^{8} m \text{/} s\end{matrix}$$

(The reader should notice here that the Ross Model predicts that the electron in the neutron is traveling about 10 percent faster than the speed of light! I know this is going to disturb a lot of people since most people believe that Professor Einstein told us that nothing can go faster than the speed of light. The reader should also notice that the Ross Model does at least agree with Professor Einstein that the mass of anything going at speeds near the speed of light will increase substantially. In this case the electron mass has increased from 9.109×10⁻³¹ kg to 23.009×10⁻³¹ kg. However, the increase in mass is not the result of the electron going fast; the increase is the result of the capture by the electron of the 13.9×10⁻³¹ kg entron.)

We can now estimate the radius of the electron in the neutron by applying Newton's second law, which asserts that the attractive force on the electron from the proton is equal to the radial acceleration of the electron so:

$$\frac{{ke}^{2}}{{r}^{2}} = \frac{{mv}^{2}}{r}$$

So:

$$\begin{matrix}r = \frac{{ke}^{2}}{{mv}^{2}} \\ = \frac{( 8.99 \times {10}^{9} {Nm}^{2} \text{/} {C}^{2} ) {( 1.602 \times {10}^{- 19} C )}^{2}}{( 9.109 \times {10}^{- 31} kg ) ( 3.3 \times {10}^{8} m \text{/} s )} \\ = 2.3 \times {10}^{- 15} m\end{matrix}$$

Based on these calculations my model of the neutron is a proton with a 0.782 MeV electron circling through or around the proton. Two possible graphical models of the neutron are shown in FIGS. 8A and 8B.

### Deuterium Nucleus

### A Deuteron

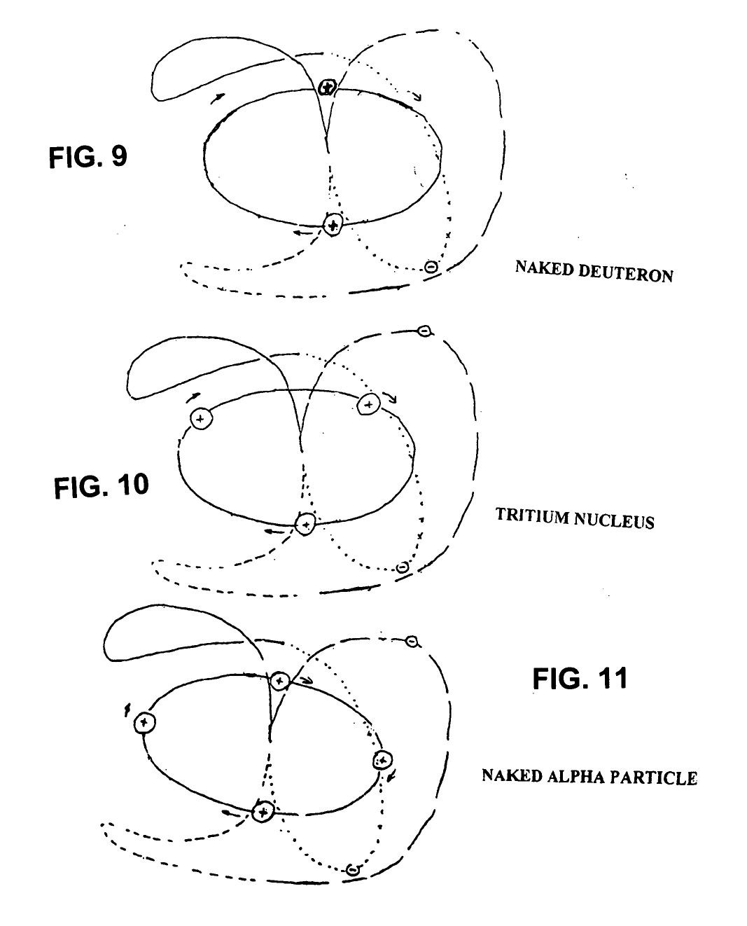

Current physics and chemistry books explain that the deuterium nucleus is comprised of a proton and a neutron plus some binding energy. The deuterium nucleus (an energetic deuteron) according to the Ross Model is simply two naked protons plus a naked electron and a number of entrons having a total mass/energy equivalent to 15.29 MeV. A 15.29 MeV entron has a diameter of about 0.890×10⁻¹⁶ m. Therefore several lower energy entrons (with larger diameters) are probably utilized to slow down the deuterium nucleus. A proposed drawing of the naked deuteron is shown in FIG. 9. The entrons are not shown.

### Tritium Nucleus

### A Triton

Current physics and chemistry books explain that the tritium nucleus (a triton) is comprised of a proton and two neutrons plus some binding energy. The tritium nucleus according to the Ross Model is simply three naked protons plus two naked electrons and enough entrons to provide an energy/mass of about 18.187 MeV. Several entrons are probably required to provide the breaking action. A proposed drawing of the triton is shown in FIG. 10. The entrons are not shown.

### The Alpha Particle

### A Helium Nucleus

Current physics and chemistry books explain that the alpha particle (which is thought to be the same as the helium nucleus) is comprised of two protons and two neutrons plus some binding energy. The alpha particle according to the Ross Model is simply four naked hydrogen atoms plus two naked electrons and a number of entrons having a total mass/energy equivalent to about 6.75 MeV. A proposed drawing of the alpha particle is shown in FIG. 11. Again, the entrons are not shown. The reader should take notice of the structure of the deuteron, the tritium nucleus and the alpha particle. For these particles will be used by the physics of stars, according to the Ross Model, to build larger atoms (without the magical “strong force”). Notice in each case the particles comprise a negative portion and a positive portion. Furthermore, the positive portion in each case is located in the center of the particle. The outside portion of each of the three particles is negative. It is very important to remember that coulomb forces decrease as the square of the distance between charges. We will see later on that the nuclei of isotopes of carbon, oxygen, neon, magnesium, silicon, sulfur, argon and calcium are comprised of nothing but three to ten alpha particles (see Table 10). The coulomb attractive forces between the negative and positive portions of the alpha particles are strong enough to exactly balance the repulsive forces acting between the like charges of the respective alpha particles. For all of these atoms other than argon the isotope is the most abundant naturally occurring isotope of the atom.

### How to Make Atoms and Molecules

As I have stated many times everything in our Universe is made from nothing but tronnies. But as we have seen above tronnies can be combined to make entrons, electrons and positrons and entrons, electrons and positions can be combined to make protons. Protons, electrons and entrons can be combined to make neutrons, deuterons, tritons and alpha particles. Now we use these composite particles (neutrons, deuterons, tritons and alpha particles) to make atoms. And then light atoms can be combined to make heavier atoms. And all of the atoms can be combined in an almost unlimited way to make molecules and every thing else in our Universe.

### The Sizes of Atoms

The sizes of atoms are generally in the range of about 10⁻¹⁸ meters. Almost all of the mass of each atom is contained in its nucleus which is about 1000 times smaller than the atom. A number of electrons between 1 and 92 circle the naturally occurring atoms. The size of nuclei is generally believed to be approximated by the following formula:

r=r₀A^{1/3}

where r is the radius, r₀=1.2×10⁻¹⁵ m and A is the mass number of the isotope. So, for example, iron-56 with a mass number of 56 would have a radius of about 5.5×10⁻¹⁵ m, since the cube root of 56 is about 4.59. The largest stable isotope is uranium-238. Its nucleus has a radius of about 6.2×10⁻¹⁵ m. Helium with a mass number of 4 would have a radius of about 1.92×10⁻¹⁵. Oxygen with a mass number of 16 would have a radius of about 3×10⁻¹⁵ M.

### Making Models of Atoms

The question for now is how are these atoms and molecules assembled? To help figure this out, first we will consider the atomic number and masses of atoms. Most atoms have several naturally occurring isotopes. The atomic number of all isotopes of all atoms is equal to the number of electrons surrounding the nucleus of the charge neutral isotope, 1 for hydrogen and 92 for uranium. And for example all charge neutral oxygen isotopes have eight orbiting electrons, so all isotopes of oxygen have an atomic number of eight.

According to the Ross Model stable atoms are comprised of only electrons, protons, and high-energy entrons. Some of these electrons, protons and high energy entrons are in the form of composite particles (i.e. neutrons, protons, deuterons, tritons and alpha particles). A low-energy entron cannot exist in an atomic nucleus, simply because it is much too large. All entrons in nuclei are gamma ray entrons or neutrino entrons (see Table V). Some of these high-energy entrons have converted the composite particles into energetic composite particles. We have estimated the mass of the naked protons, we know the mass of the naked electron. The actual mass of all isotopes of all atoms are known with great accuracy from careful experiments.

### Building of Atoms

According to the Ross Model, the nuclei of most of the isotopes of most atoms are comprised mostly of alpha particles. Atoms are made in stars. There are lots of alpha particles in stars because stars are mostly made of hydrogen and helium. However, at the temperature of the internal structure of stars the hydrogen and helium atoms are ionized which means that we are talking about the nuclei of helium and hydrogen and separate electrons. Stars are extremely hot and that hot is nothing but entrons as we have explained above, so there are an enormous quantity of high energy entrons available in stars. According to the Ross Model these composite particles are the building blocks of the nuclei of atoms.

In Table X, I have listed 61 isotopes having a spin of zero and a mass number evenly divided by four. The lightest of these isotopes are believed by me to be comprised of nothing but alpha particles and entrons. I am proposing that the heavier isotopes listed in Table 10 also contain the number of electrons specified in Table X. In Table XI, I have listed isotopes of typical atoms along with their atomic masses and spins. These nuclei can be constructed with alpha particles and entrons plus an appropriate number of additional electrons and/or protons which may be in the form or neutrons, deuterons and tritons. In Table XII I have listed atomic masses of typical naturally occurring isotopes. I have also listed the combined masses of naked protons and naked electrons in each of the isotopes and have calculated the mass difference between these values and the total mass of each isotope so as to estimate the mass of the entrons in the isotopes. In each case in making models of atoms, care must be exercised to assure that masses and charges of the models correspond to experimental data.

TABLE X
Alpha Particle Combinations to Form Atomic Nuclei

| | | | Number | | |
|---|---|---|---|---|---|
| | Atomic | Mass | of Alpha | | Percent |
| Atom | Number | Number | Particles | Electrons | Abundance |
| Helium | 2 | 4 | 1 | 0 | 100 |
| Beryllium | 4 | 8 | 2 | 0 | 0* |
| Carbon | 6 | 12 | 3 | 0 | 98.9 |
| Oxygen | 8 | 16 | 4 | 0 | 99.8 |
| Neon | 10 | 20 | 5 | 0 | 90.5 |
| Magnesium | 12 | 24 | 6 | 0 | 79.0 |
| Silicon | 14 | 28 | 7 | 0 | 92.2 |
| Sulfur | 16 | 32 | 8 | 0 | 95.0 |
| Argon | 18 | 36 | 9 | 0 | 0.336 |
| Calcium | 20 | 40 | 10 | 0 | 96.9 |
| Argon | 18 | 40 | 10 | 2 | 99.6 |
| Calcium | 20 | 44 | 11 | 2 | 2.1 |
| Titanium | 22 | 48 | 12 | 2 | 73.7 |
| Chromium | 24 | 52 | 13 | 2 | 83.8 |
| Iron | 26 | 56 | 14 | 2 | 91.8 |
| Nickel | 28 | 60 | 15 | 2 | 26.2 |
| Zinc | 30 | 64 | 16 | 2 | 48.6 |
| Zinc | 30 | 68 | 17 | 4 | 18.4 |
| Germanium | 32 | 72 | 18 | 4 | 27.7 |
| Germanium | 32 | 76 | 19 | 4 | 7.44 |
| Selenium | 34 | 80 | 20 | 6 | 46.6 |
| Krypton | 36 | 80 | 20 | 4 | 2.25 |
| Krypton | 36 | 84 | 21 | 6 | 57.0 |
| Strontium | 38 | 84 | 21 | 4 | 0.56 |
| Strontium | 38 | 88 | 22 | 6 | 82.6 |
| Zirconium | 40 | 92 | 23 | 6 | 17.1 |
| Zirconium | 42 | 96 | 24 | 8 | 2.8 |
| Molybdenum | 42 | 100 | 25 | 8 | 9.36 |
| Rubidium | 44 | 104 | 26 | 8 | 18.7 |
| Palladium | 46 | 108 | 27 | 8 | 26.5 |
| Cadmium | 48 | 112 | 28 | 8 | 24.1 |
| Cadmium | 48 | 116 | 29 | 10 | 7.5 |
| Tin | 50 | 120 | 30 | 12 | 32.6 |
| Tin | 50 | 124 | 31 | 12 | 5.8 |
| Tellurium | 52 | 128 | 32 | 12 | 31.7 |
| Xenon | 54 | 132 | 33 | 12 | 26.9 |
| Xenon | 54 | 136 | 34 | 14 | 8.9 |
| Barium | 56 | 136 | 34 | 12 | 7.8 |
| Cesium | 58 | 140 | 35 | 12 | 88.5 |
| Neodymium | 60 | 144 | 36 | 12 | 23.8 |
| Neodymium | 60 | 148 | 37 | 14 | 5.7 |
| Samarium | 62 | 148 | 37 | 12 | 11.3** |
| Samarium | 62 | 152 | 38 | 14 | 26.7 |
| Gadolinium | 64 | 156 | 39 | 14 | 20.5 |
| Gadolinium | 64 | 160 | 40 | 16 | 21.9 |
| Dysprosium | 66 | 160 | 40 | 16 | 2.34 |
| Dysprosium | 66 | 164 | 41 | 16 | 28.2 |
| Erbium | 68 | 164 | 41 | 14 | 1.61 |
| Erbium | 68 | 168 | 42 | 14 | 26.8 |
| Ytterbium | 70 | 172 | 43 | 16 | 21.9 |
| Ytterbium | 70 | 176 | 44 | 18 | 12.9 |
| Tungsten | 74 | 180 | 45 | 16 | 0.12 |
| Tungsten | 74 | 184 | 46 | 18 | 30.6 |
| Osmium | 76 | 188 | 47 | 18 | 13.3 |
| Osmium | 76 | 192 | 48 | 20 | 41.0 |
| Platinum | 78 | 196 | 49 | 20 | 25.3 |
| Mercury | 80 | 200 | 50 | 20 | 23.1 |
| Mercury | 80 | 204 | 51 | 22 | 6.87 |
| Lead | 82 | 204 | 51 | 20 | 1.4 |
| Lead | 82 | 208 | 52 | 22 | 52.4 |

There are no naturally occurring 53-57 alpha isotopes.

| | | | | | |
|---|---|---|---|---|---|
| Thorium | 90 | 232 | 58 | 26 | 100*** |
| Uranium | 92 | 236 | 59 | 26 | 0**** |

*Beryllium-8 half life is 7 × 10⁻¹⁷ seconds - decay products are two alpha particles.
**Samarium-62 half life is 7 × 10¹⁵ years - decay product is an alpha particle.
***Thorium-232 half life is 1.4 × 10¹⁰ years - decay product is an alpha particle.
****Uranium 236 half life is 2.34 × 10⁷ years - decay product is an alpha particle.

We also know that atoms have spin and we know the spin is not the same in all atoms. So we can now utilize all of this information to predict how each of the atoms is constructed. In this specification I have not tried to describe all isotopes of all atoms. There are 92 distinct naturally occurring types of atoms, each type having its own atomic number and chemical properties that have at least one stable isotope. Most of these 92 atoms have more than one stable isotope and many unstable isotopes. So there are several hundred isotopes. I have picked only a few isotopes for examples and will try to describe their structure. Information for Tables X, XI and XII are extracted from the 77^{th} (1996-1997) Edition of the CRC Handbook of Chemistry and Physics, published by CRC Press.

In Table XII, I have listed the calculated mass difference between the measured masses of some typical isotopes and the sum of the Ross Model estimated masses of the naked protons and electrons making up each of the listed isotopes. I have also included the electron and the neutron and the electron. This difference according to the Ross Model is equal to the mass of the entron or entrons in the isotope. You should notice that this mass difference for the iron-56 isotope is zero. This results from the fact that I used this isotope to estimate the mass of the naked proton under the assumption that there were no entrons with significant mass in the iron-56 isotope.

TABLE XI
Atomic Masses and Spin

| | A- | | | | |
|---|---|---|---|---|---|
| | tomic | | Abun- | | |
| | Num- | Atomic | dance | Atomic Mass | |
| Atom | ber | Isotope | (percent) | (amu) | Spin |
| Electron | | | | 0.00054856 | ½+ |
| Neutron | 0 | ₀n | | 1.00866492 | ½+ |
| Hydrogen | 1 | ¹H | 99.985 | 1.00782 | ½+ |
| Deuterium | 1 | ²H | 0.015 | 2.014101778 | 1+ |
| Tritium | 1 | 3H | 0 | 3.01602931 | ½+ |
| | | | (12.32 y) | | |
| Helium | 2 | ²He | 100 | 4.00260325 | 0+ |
| Lithium | 3 | ⁷Li | 92.5 | 7.0116004 | 3/2− |
| Beryllium | 4 | ⁹Be | 100 | 9.0121821 | 3/2− |
| Boron | 5 | ¹¹B | 80.1 | 11.009306 | 3/2− |
| Carbon | 6 | ¹²C | 98.89 | 12.000000 | 0 |
| Nitrogen | 7 | ¹⁴N | 99.634 | 14.00307401 | 1+ |
| Oxygen | 8 | ¹⁶O | 99.762 | 15.99491462 | 0 |
| Fluorine | 9 | ¹⁹F | 100 | 18.9984032 | ½+ |
| Neon | 10 | ²⁰Ne | 90.48 | 10.99244018 | 0 |
| Sodium | 11 | ²³Na | 100 | 229897697 | 3/2+ |
| Magnesium | 12 | ²⁴Mg | 78.99 | 23.9850419 | 0 |
| Aluminum | 13 | ²⁷Al | 100 | 26.9815384 | 5/2+ |
| Silicon | 14 | ²⁸Si | 92.23 | 27.9769265 | 0 |
| Phosphorus | 15 | ³¹P | 100 | 30.9737615 | ½+ |
| Iron | 56 | ⁵⁶Fe | 91.75 | 55.934942 | 0 |
| Gold | 197 | ¹⁹⁷Au | 100 | 196.966552 | 3/2+ |
| Lead | 208 | ²⁰⁸Pb | 52.4 | 207.976636 | 0 |
| Uranium | 235 | ²³⁵U | 0.72 | 235.043923 | 7/2− |
| Uranium | 238 | ²³⁸U | 99.274 | 238.050783 | 0 |

TABLE XII
Nuclear Masses

| | | | | Mass of | | |
|---|---|---|---|---|---|---|
| | | | | Naked | Total | |
| | | | | Protons & | Enton | Entron |
| | Atomic | Atomic | Atomic Mass | Electrons | Mass | Energy |
| Atom | Number | Isotope | (amu) | (amu) | (amu) | (MeV) |
| Electron | | | 0.000548 | 0.000584 | 0.0 | 0.0 |
| Neutron | 0 | ₀n | 1.00866492 | 0.99883825 | 0.00982667 | 9.1585 |
| Hydrogen | 1 | ¹H | 1.00782 | 0.99883825 | 0.00898175 | 8.3701 |
| Deuterium | 1 | ²H | 2.014101778 | 1.9976765 | 0.016425278 | 15.3084 |
| Tritium | 1 | 3H | 3.01602931 | 2.99651475 | 0.01951456 | 18.1876 |
| Helium | 2 | ⁴He | 4.00260325 | 3.9953530 | 0.00725025 | 6.7572 |
| Lithium | 3 | ⁷Li | 7.0116004 | 6.99186775 | 0.01973265 | 18.3514 |
| Beryllium | 4 | ⁹Be | 9.0121821 | 8.98954425 | 0.02263785 | 21.0985 |
| Boron | 5 | ¹¹B | 11.009306 | 10.98722075 | 0.02208525 | 20.5529 |
| Carbon | 6 | ¹²C | 12.000000 | 11.986069 | 0.013931 | 12.9837 |
| Nitrogen | 7 | ¹⁴N | 14.00307401 | 13.9837355 | 0.01933851 | 18.0235 |
| Oxygen | 8 | ¹⁶O | 15.99491462 | 15.981412 | 0.01350262 | 12.5844 |
| Fluorine | 9 | ¹⁹F | 18.9984032 | 18.97792675 | 0.02047645 | 19.0840 |
| Neon | 10 | ²⁰Ne | 19.9924402 | 19.976765 | 0.0156842 | 14.6177 |
| Sodium | 11 | ²³Na | 22.9897697 | 22.97327975 | 0.01648995 | 15.3686 |
| Magnesium | 12 | ²⁴Mg | 23.9850419 | 23.972118 | 0.0129239 | 12.0281 |
| Aluminum | 13 | ²⁷Al | 26.9815384 | 26.96863275 | 0.01290565 | 12.0289 |
| Silicon | 14 | ²⁸Si | 27.9769265 | 27.967471 | 0.0094555 | 8.8125 |
| Phosphorus | 15 | ³¹P | 30.9737615 | 30.96398575 | 0.00977575 | 9.1110 |
| Iron | 56 | ⁵⁶Fe | 55.934942 | 55.934942 | 0.000000 | 0 |
| Gold | 197 | ¹⁹⁷Au | 196.966552 | 96.7711353 | 0.1954167 | 182.13 |
| Lead | 208 | ²⁰⁸Pb | 207.976636 | 207.758356 | 0.21828 | 203.44 |
| Uranium | 235 | ²³⁵U | 235.043923 | 234.7269888 | 0.3169342 | 295.38 |
| Uranium | 238 | ²³⁸U | 238.050783 | 237.7235035 | 0.3272795 | 305.02 |

It is my hope that the information of the type listed above along with the concepts of the Ross Model can be utilized to model the nucleus of every isotope of every atom. Hopefully, structures can be developed under which charges, masses and spins all are consistent with experimental data. It is fairly easy to propose nuclear structures in which charges and masses are consistent. For example in Table X I have assumed that the nuclei of all zero spin isotopes with atomic masses evenly divisible by 4 are comprised of only alpha particle and entrons or only alpha particles entrons and electrons. For the time being I will leave to those that understand spin to develop structures that are consistent with the spin data. For example isotopes with atomic masses evenly divisible by 2 but not evenly divisible by four also have zero spin. There is probably a good explanation for this pattern that can be explained by the Ross Model but I have not yet developed that good explanation. However, I have made actual models of carbon, oxygen, neon, magnesium, silicon, sulfur, argon and calcium with small acrylic balls and acrylic glue, each ball representing one alpha particle. All of these isotopes have zero spin as does the alpha particle, so I could propose structures without understanding spin. The closest together structures are obvious. Two oxygen structures with five alphas fit together to make a calcium structure with 10 alphas.

### Electricity and Magnetisms

In our modern societies almost everything we do involves electricity and magnetism. All of our electronic gadgets and all of our motors depend on the forces of electricity and magnetism. Strange as it may seem, existing theories do not provide a clear picture of either electricity or magnetism. If you do not believe it, GOOGLE either term. You will find the no one knows what an electron looks like or what it is made of. You will also discover we know how to create magnetic fields, but no one knows what a magnetic field is. You may also discover that no one has a good explanation of voltage. We all know that most of our home appliances operate at 120 volts AC or 240 volts AC and that our cameras, radios and cell phones operate from DC batteries at lower DC voltages. But what the heck is voltage anyway? The explanations that you will see talk about electric charge and the Coulomb force associated with the charge. But voltage represents energy, so what has charge got to do with energy. Don't get me wrong, scientist and engineers have learned how to deal with electricity and magnetism even though they do not understand it. They have developed mathematical formulas that make accurate predictions and these formulas work very well. We use them to design huge hydroelectric generators and microscopic integrated circuits. But the prior art science still do not know what an electron looks like and it certainly does not know what a magnetic field looks like.

### Magnetism

Magnetism according to the Ross model is nothing but naked (zero voltage) electrons looping through and around magnetic materials at the naked electrons' natural speed of 2.18 million meters per second (2.18×10⁶ m/s). Our earth's magnet field is produced by these naked electrons that loop through and around our earth (with a diameter of about 6 million meters in a few seconds. In permanent magnets naked electrons flow freely through the atomic matrix of the magnetic material at their natural speed of 2.18×10⁶ m/s until the electrons reach one of the poles of the magnetic then the naked electrons continue at the same speed looping outside the magnet and back in the opposite pole. Electric generators force a conductor through a magnetic field of these naked electrons. The electrons in the conductor are energetic electrons at an electric potential determined by the design of the generator. Naked electrons are stripped from the magnetic field by the conductor and become conduction electrons in the conductor. Once inside the conductor the naked electrons, moving at about 1 percent of the speed of light interact with the energetic electrons in the conductor so that the electrical energy in the conductor is shared equally by all of the conduction electrons.

### Voltage, Entrons and Photons

Electrons, positrons and protons have been described above based on the Ross Model. According to the Ross Model, the voltage on a high-voltage electrical conductor is determined by the energy (in volts) of entrons captured by all of the conduction electrons in the conductor. For example, in a conductor connected to the hot (the one not grounded) terminal of a grounded 12-volt battery, all of the conduction electrons have captured an entron with an energy of about 12 eV and a diameter of about 1.0×10⁻¹¹ m. Any electrons at the ground terminal of the battery would have an energy corresponding to the temperature of the terminal. At normal temperatures such as about 300 K (23 C), the energy would be about 1.4×10⁻⁵ eV and the entron diameter would be about 9.6×10⁻⁶ m.

The high voltage terminal of a 2.3 volt battery would provide entrons with a diameter of about 5.9×10⁻¹⁰ m and these entrons in photon form would be visible green light with wavelengths of 5.4×10⁻⁷ m. Entrons in these low voltage ranges are about 10 million times larger than electrons that have captured them. When electrons flow through a resistor they tend to lose their entrons in the resistor. These lost entrons are the heat energy produced by the electric current flowing through the resistor. When entrons are lost in a light emitting diode they escape as photons with energies corresponding closely with the diode supply voltage. When batteries are connected in series, entrons representing the battery voltage add to the energy of the electrons at the low voltage terminal of each battery, so three 12-volt batteries in series will produce electrons with entron energies of about 36 eV.

Let us consider three 12 volt batteries (A, B and C) connected in series. At the low voltage terminal of 12 volt battery A, each conduction electron will have absorbed an entron with a diameter corresponding to ground energy. At the high voltage terminal all conduction electrons will have a diameter of about 1.1×10⁻¹⁰ m. At the low voltage terminal of a 12 volt battery B all conduction electrons will have captured an entron with the same energy and diameter as the electrons at the high voltage terminal of battery A (i.e. 12 volts and 1.1×10⁻¹⁰ m). Electrons at the high voltage terminal of battery B will be at 24 eV with entron diameters of 0.55×10⁻¹⁰ m and the corresponding high voltage terminal of battery C all conduction electrons will be at an energy of 36 eV with entrons with diameters of 0.75×10⁻¹⁰ m.

### Electric Current

At normal temperatures all electrons in atoms other than conduction electrons are in their ground states and are orbiting around or through the nuclei of an atom. These electrons typically have no captured entrons and in the Ross Model they are called naked electrons as explained above. They are circling the nucleus at an average velocity of about 2.18×10⁶ m/s. Conduction electrons in an atomic matrix typically are not attached to any atom and are moving freely in the matrix of atoms. The conduction electrons typically have captured at least one entron and would be traveling at a velocity different from 2.18×10⁶ m/s (slower for low voltage electrons and faster for high voltage electrons). Low voltage entrons captured by atomic electrons (in addition to normally slowing them down) also put them in excited states. They drop from their excited states to a lower excited state or ground state by releasing the entrons (often as photons) and if they release all of their entrons to return to the ground state they speed back up to 2.18×10⁶ m/s. The entrons captured by conduction electrons define the electron's energy or voltage. The tronnies of low-energy entrons (less energetic than 13.6 eV) loop through electrons and the Coulomb forces from the looping tronnies provide a backward force on the electrons to slow down the electrons to reduce the electron velocity and kinetic energy. A 13.6 eV entron reduces the electron velocity to about zero. Higher energy entrons give the electron a velocity that can be any velocity up to 1.414 times the speed of light in a direction opposite the direction of its naked velocity.

As indicated by Table V, entrons with energies in the range of a few volts have dimensions about the size of atoms (about 10⁻¹⁰ m) and as indicated by FIG. 12, electron speeds are normally a fraction of the speed of light. Therefore, the association between an electron and the entron it has captured is probably a very loose one. So entrons can jump off a high-voltage electrons coming out of the battery and travel through a conductor very quickly until all of the conduction electrons in the conductor have captured entrons of the same energy. At this point the entire conductor between the high voltage terminal of the battery and a lamp powered by the battery is charged to 12 volts. As billions of capturing electrons near the lamp attempt to pass through (at almost the same time) the filament of the lamp the entrons escape from the capturing electrons and become quanta of heat in the filament. As explained below entrons captured in matter are the heat quanta in the matter and define the temperature. The more captured entrons the greater the heat and the higher the temperature. Entrons captured in matter can share energy with each other to produce an energy distribution. Some of these entrons will escape the filament in the form of photons. If the temperature is high enough some of these photons will be visible light photons.

### Special and General Relativity and Uncertainty

### Special Relativity

A very important feature of the Ross Model is that photons travel in Coulombic reference frames at the vacuum speed of light. If the reference frame is moving in the same direction as the photon with a particular velocity vᵣ then the photon velocity is vᵣ+c. If the reference frame is moving with a velocity of vᵣ in the opposite direction of the photon then the photon's speed is vᵣ−c. For example, if a Coulombic reference frame, such as that of the earth, is moving through our Universe at a speed of 0.1 percent c in a direction opposite the direction of a light beam, the light beam passing through the Coulombic reference frame will slow down to 99.9 percent c. If the reference frame is moving at a speed of 0.2 percent c in the same direction of a light beam passing through it, the light beam will speed up to a speed of 100.2 percent c. So that someone measuring the speed of light with equipment moving with the reference frame will measure the speed of light as the difference between (1) the speed of the frame and (2) the speed of light. In both cases the measured speed of light will be constant at c. Professor Einstein assumed that the speed of light was constant based on the results of the Michelson-Morley experiments that showed that the “measured” speed of light is always constant. This explanation of light speed makes some of the most complicated features of the Special Theory of Relativity unnecessary.

### General Relativity

Professor Einstein's did not recognize that matter-penetrating photons, neutrino photons, are responsible for gravity. My discovery that neutrino photons “carry” gravity makes most of the complicated features of General Relativity unnecessary if not wrong. Certainly, masses do not curve space. Space is merely the emptiness between things—it is nothing, you can't curve it. Space is also infinite in all three dimensions and there are only three dimensions: up and down, left and right and forward and backwards. Time is not a forth dimension; time is a measurable period between events. Time is absolute and is not affected in the least bit by how fast one is moving. My model brings logic back into science. If a fast train A is traveling east at 0.9 c and fast train B is traveling west toward train A on the same track at 0.9 c. People watching from train station C equidistance from the two trains, as well as people watching from each train will all conclude that the two trains are approaching each other at 1.8 c. If a galaxy is moving away from the earth at 0.9 c and a space ship is flying within the galaxy at a speed of 0.9 c relative to the center of the galaxy in the same direction that the galaxy is moving, that space ship is traveling at 1.8 c away from the earth.

### Uncertainty Principal

The prior art idea that uncertainty is a basic element of physics is wrong according to the Ross Model. There may be things going on that we have no way of measuring precisely, but the physics is completely precise. Coulombs law and its derivations apply to infinitely small dimensions and at all speeds. The fundamental particles in our Universe are point particles so their position wherever it is should be infinitely precise. Coulombs law is infinitely precise, at least as far as we know. Time is absolute. There is no limit to how many times you can divide a second. So our Universe is infinitely precise. Currently, our instruments are not infinitely precise, but they are getting better and better.

### Tronnies are Required by Coulomb's Law

Coulomb's Law says that the force between two charges is proportional to the product of the charges and inversely proportional to the square of the distance between them. At distances infinitely close to zero, the Coulomb force approaches infinity. A consequence of this law is that elementary charged particles must be point charges with no volume or any other dimension. Otherwise, the elementary charged particle would blow itself apart with infinite or near infinite force. It is obvious that a point cannot have mass. Infinite density makes no sense. Therefore, all charged particles must be charged point particles or be made up of charged point particles. This is the essence of the Ross Model. The question is: “Could an elementary charged point particle travel at speeds less than the speed of light.” The answer is “No”. The Coulomb force on a charge A from a like charge A′ is felt by A based on the position of A′ when the force (traveling at the speed of light and reaching A) left A′. Therefore, if a mass-less point charge ever attained a speed equal to or greater than the speed of light, forces from its own past would assure that it never slowed down to a speed of less than the speed of light. I believe no tronnie ever traveled more slowly than the speed of light but if it did the Coulomb forces from two nearby like charges (each pushing the particle at the speed of light) would drive the mass-less point particle away at speeds greater than the speed of light. Once it is going away from a past position of itself faster than the speed of light its own past (especially its immediate past) will keep it going at least the speed of light. Therefore, we can assert that every elementary charged particle in our Universe must be a mass-less point particle doomed to always travel at speeds equal to or greater than the speed of light.

### Are Photons a Particles or Waves?

The prior art does not know whether light is a wave or a particle. The Ross Model says a photon is both a wave and a particle. The entron portion of the photon is a particle in the same sense that an electron is a particle. (An entron is comprised of two tronnies and an electron [a naked electron] is comprised of three tronnies.) The entron carries the mass of the photon. The entron can exist in many forms other than as a component of a photon. It can be captured by an electron or a proton to become part of the electron or the proton. It can be trapped in matter in the form of a heat quantum, later to be released as part of another photon. But the entron and all the other entrons in a beam of light (with their charges) produce Coulomb force waves that travel out from their positions spherically to produce a Coulomb wave structure in which the entrons in the beam ride. The entron of a single photon can create a complex wave traveling at the speed of light on which the photon can travel at the speed of light through a laboratory or through our Universe. The photon is the combination of the entron particle and the Coulombic wave the entron produces and in which the entron rides. So the photon is a particle and a wave!

### Reflection and Refraction

The looping path of the entron viewed from the Coulombic reference frame through which the photon is traveling has the speed of the entron varying from 3c to minus c and dropping to zero once each wavelength of the photon. The entron travels backwards through a significant portion of each wavelength. At surfaces such as the surface of a lake, a mirror, a window or a tree leaf, Coulombic fields flow out from the surface at the speed of light perpendicular to the surface. Therefore it is easy for an entron to change directions at surfaces. Entrons floating in a beam of light intersecting these surfaces at an incident angle float in the Coulombic field flowing out from the surface as well as the Coulombic field of its own incoming beam so they often reflect from the surface at a reflection angle equal to the incident angle. Entrons illuminating a material of higher index of refraction that are not reflected or absorbed at the surface of a material flow with its wave into the material at a slower speed bending toward the normal to the surface in a wave-like pattern.

### A “Single Photon-Two Slit” Explanation

One of the fundamental mysteries of physics is the single photon-two slit experiment. In this experiment single photons (coming one at a time) illuminating two slits in a first screen produce a diffraction pattern on a second screen. This mystery is described in many physics books. For example, Fundamentals of Physics, Halliday, Resnick and Walker, Sixth Ed., John Wiley &Sons, Inc. at pages 962-964. The question is how could single photons produce diffraction patterns. How could a photon passing through one of the two slits even be aware that there is a second slit? The best explanation the prior art can give is that the light is produced as a photon and is absorbed as a photon but “travels between the source and the detector as a probability wave”. The Ross Model provides a much simpler solution. The entron portion of each photon passes through only one of the two slits but its Coulombic wave passes through both slits and both parts of its wave combine to direct the path of the entron portion of the photon on the opposite side of the first screen.

### Polarization

The two tronnies of each entron spin in a plane. If the entron is the energy portion of a photon, the photon spins in the plane of the entron spin which also includes the photon direction. In most light beams the spin direction of the entron and its photon is random about the photon direction (the photon axis). Light beams become partially polarized upon reflection from smooth surfaces. This is because the entrons want to circle parallel to both the direction of the beam and the direction perpendicular to the surface. This is natural for the plane that includes the directions of incoming beam and the reflected beam, so this is one of the polarizations. This plane includes the normal to the surface. The other reflected polarization is perpendicular to that direction. I recognize that this explanation of polarization appears a little flakey. I have tried many explanations of polarization but none seem really simple. I have also tried to understand polarization under other theories of light. None really make much sense to me. Light can be polarized by a number of techniques other than reflection and the polarization of a light beam can be changed with wave plates and it can be rotated with magnetic fields. I believe my model can explain polarization but it is probably going to take someone much more expert in optics than I who is a believer in tronnies and entrons to provide that explanation.

### Photon Absorption

When photons react with matter, they may be reflected or transmitted without loss of energy. They may also be absorbed to create an excited atom or molecule. And they may be absorbed in the matter as heat energy. High-energy x-rays and gamma rays are attenuated via the photo-electric effect, Compton scattering or pair production. It is the entron that is the energy/mass of the photon. When the photon is trapped in matter for a short time or for a very long time, it ceases to exist as a photon but its entron does not cease to exist. It can however transfer part of its energy to other entrons or the tronnies of entrons can change partners with the tronnies of another entron. For example, more than one entron can be captured by the same electron. When this happens, the tronnies of the one of entrons is brought closer to the tronnies of a separate entron than it is to its partner. The result can be a higher energy entron and a lower energy entron. In a microwave oven entrons of a single relatively low frequency become absorbed in what is cooking and the result is a hot product with a wide range of entron energies. These are radiated away or conducted away as the product cools. As discussed above, three entrons (a neutrino entron a 1.05 MeV gamma ray entron and a low energy entron) can produce an electron and positron pair. Most entrons trapped in matter radiate from the matter in the form of photons In a reaction described as the photoelectric effect, the entron portion of the photon is absorbed by an electron giving the electron all of the entron energy. In Compton scattering the entron is absorbed by an electron, but an entron previously a part of the electron is ejected and we monitor the ejected entron as a photon.

### Heat and Temperature

Heat is nothing more than entrons (circling tronnie pairs) temporarily trapped in matter. Temperature is a measure of that heat. We warm up when our bodies absorb the entrons of photons radiated from a camp fire or the sun, and we cool down when our body radiates photons with wavelengths in the infrared and millimeter wave range. The entrons of microwave radiation warms our TV dinners. We typically must wait a few minutes for some of the entrons to radiate away so that the dinners have cooled enough for us to eat them. According to this embodiment heat and temperature, of a solid, liquid or gas, are expressions of entrons (or tronnie pairs) which have been captured and are temporarily located in the solid liquid or gas. According to this model, all atoms and molecules naturally include a number of tronnie pairs (entrons of neutrinos, gamma rays and other photons) that help define the basic atom or molecule in its natural unheated state (i.e., its absolute zero temperature state).

### The Life and Death of Universes

### Recycling on a Grand Scale

Each universe has a lifetime. It is born from a basketball size in a Big Bang, expands very quickly at first then more slowly for a long period of time (such as about 50 billion years) to a volume many billions of light years across; then it contracts for another long period (such as another 50 billion years) then it collapses to basketball size and dies in another Big Bang that is the beginning of the next universe. This is recycling on a grand scale! So, according to this model the universe we live in is a number in a series of universes. I doubt if we will ever know what the number of our Universe is. We could guess. For example, we might propose that our Universe is Universe 47, created at the demise of Universe 46 and when our Universe ends in the next Big Bang its recycled tronnies will create Universe 48. Scientist estimate that our universe is about 15 billion years old and is still expanding. The Ross Model attributes this expansion to the pressure produced by the impact of relatively low energy photon exchanged between far away galaxies. Neutrino photons, the carriers of gravity within a galaxy are absorbed and/or scattered by hydrogen currently sparsely dispersed in inter-galactic space, so neutrino photon produced gravity is not effective between far away galaxies.

### The End of Our Universe

It may be that when a sufficient portion of the free hydrogen in the space between galaxies has been sucked into galaxies, the neutrinos from the black holes of the separate galaxies will begin to pull all galaxies together into one gigantic black hole. This largest of all black holes may exist for a long time continuing to suck in surrounding matter and breaking it down to protons and then destroying the protons to produce neutrino photons and gamma ray photons as described above. At some point in the life of the largest of all black hole, the process of proton destruction will accelerate providing an exponential increase in the black hole's gravity which further accelerates the proton destruction so that in a very short period (maybe less than a few seconds) the black hole collapses to a size smaller than a basketball and all remaining protons and electrons are destroyed so that nothing is left but gamma ray photons and neutrino photons which explode out of a basketball size birthplace in a Big Bang to create our successor universe.

### The Birth of the Next Universe

Following the Big Bang destruction of this largest of all black holes, the released neutrino and gamma ray photons expand out much faster than the speed of light. This is the inflation period of the next universe. A reader may ask, “How can photons go faster than the speed of light?” In the Ross Model light speeds up as it passes into a Coulombic field moving in the same direction as the light. For example, if a Coulombic field moving out at the speed of light is produced by a group of photons expanding from the center of the black hole, then a second group of photons surrounding the first set could move out at twice the speed of the first group. Then a third group of photons surrounding the second group could move out at three times the speed of light. We can imagine a great many of groups of photons; so the speed of the last group could be any speed many times faster than the speed of light. The prior art suggest that at the very beginning of our Universe there was this inflation period where our Universe did in fact expand out much faster than the speed of light, but the prior art does not have an explanation for the fast expansion. And this explanation is at odds with the prior art theories since those theories limit all speed at the speed of light. The Ross Model has no such limit.

The principal products of the destruction of protons and the Big Bang as explained above are gamma ray photons and neutrino photons. When the new universe has expanded sufficiently, gamma rays and neutrino photons and low-energy photons will begin combining to form electrons and positrons in pair production processes. The electron can capture neutrino photons to become the very high energy electrons needed to form protons. The high energy electrons then capture two positrons to form naked protons. These naked protons capture entrons having combined energies of 8.37 MeV entron to slow down and then capture one electron each to form hydrogen atoms. Lower energy photons provide an expansion force and the neutrino photons provide a gravitational force so that matter in the universe tends to congregate. At great congregations lower energy photons are absorbed and neutrino photons are scattered randomly out of the congregation providing a type of gravity for the congregation producing further congregation. So stars and galaxies and black holes are born. Stars generate larger atoms in fusion processes and heavier atoms are produced in explosions of stars. Planets are formed from the dust of the universe and in due course life evolves on some of the planets.

### Everything in Our Universe is Made from Two Halves of Nothing

Tronnies are point particles with no mass and no volume, so two of them (a plus tronnie and a minus tronnie) are two halves of nothing. Tronnies are the fundamental particles from which everything in our Universe is made. Entrons, naked electrons and naked positrons are composite particles made from tronnies. Naked protons are also composite particles made from electrons, positrons and entrons. Alpha particles are composite particles made from electrons, protons and entrons. Everything else in our Universe is made from these composite particles. So basically everything in our Universe is made from tronnies. By everything, I mean everything, including all atoms, molecules, heat, gravity, our earth, its moon our sun, our galaxy and all 100 billion galaxies in our Universe, all made from tronnies or the composite particles that are made from tronnies. Tronnies, having no mass and no volume and opposite charges with the ability combine to create mass and energy and being two halves of nothing, provides a logical explanation for how a universe such as our Universe could be made from nothing (empty space).

### Self-Propulsion of Small Things

Photons are self-propelled. Photons are each comprised of one entron traveling in a circle at a speed of 2c and forward at a speed of c (the speed of light). Naked electrons and positrons are self-propelled by their own internal Coulomb forces at a significant fraction of the speed of light but can capture low-energy entrons to slow down. Protons and alpha particles and atomic nuclei of small atoms are also self-propelled and slow down with the capture of high-energy entrons. Electrons, positrons, protons and alpha particles can be propelled at high energies to speeds close to the speed of light by captured high-energy entrons, in directions opposite their natural direction of travel. These high-energy entrons each has a mass that corresponds to their energy based on Albert Einstein's famous equation:

E=mc² (3)

Particles that capture entrons are propelled by the captured entrons. The mass of the captured entrons add to the mass of the particles they are propelling. Therefore, the speed of high-speed particles can only be increased with a corresponding increase in the mass of the particles. Thus, the Ross Model, like Albert Einstein's special theory of relativity, provides an explanation as to why the mass of particles traveling close to the speed of light have substantially greater mass as compared to similar slow speed particles. This increase in mass with energy results in a limit on the speed of the energetic particles when the mass of the propelling entron becomes very large compared to the mass of the particle being propelled. In FIG. 12 for example I have plotted the speeds of the electron and the proton as a function of the energy (in joules) of its captured entron. When the entron energy is close to the natural kinetic energy of the particle, its speed approaches zero. Higher energy entrons result in increasing speed in the opposite directions. The net speed is determined by the well-known relationship:

$$E = ( 1 / 2 ) {mv}^{2} , or$$

$$v = \sqrt{\frac{2 E}{m}}$$

But now the mass includes the mass of both the particle m_{N} and its captured entron mₑ and the energy E is the difference between the natural energy E_{N} and the energy of the entron Eₑ. Therefore, the velocity of the particle is determined by the following formula:

$$v = \sqrt{\frac{2 ( {E}_{N} - {E}_{e} )}{{m}_{N} + {m}_{e}}}$$

When the energy of the entron is much greater than the natural energy of the particle and the mass of the entron is much greater than the mass of the particle Eₙ and m_{N} become negligible and the above equation reduces to:

$$v = \sqrt{\frac{2 {E}_{e}}{{m}_{2}}} = \sqrt{\frac{2 {m}_{e} {c}^{2}}{{m}_{e}}} = 1.414 c$$

since the energy of the entron Eₑ is equivalent to mₑc². So you can see that the velocity of any particle driven by entrons is limited to the square root of two times the speed of light (i.e. 1.414c). Readers should compare this speed limit to Professor Einstein's speed limit of c, the speed of light.

FIG. 12 shows electron velocity as a function of entron energy. Also as the electron speed approaches the speed of light the diameter of the driving entron gets increasingly smaller causing the electron to move in circles that become smaller with increasing energy of the entron. Therefore, the straight line speed of an electron driven by an entron is probably substantially less than 1.414 c. The two curves in FIG. 8 are not continued in the region of the speed of light because the Ross Model proposes that very high energy entrons drive the particles that have captured them in a circle the diameter of which is the same as the diameter a photon would have if the entron in question were traveling in the form of a photon at the speed of light. (As explained above the high energy electron in the Ross Model proton has a velocity of 1.57 times the speed of light, but its path is circular and the extra velocity is the result of the electrons' Coulomb forces from across the diameter of the electron's circular path. Professor Einstein taught that the particles mass increases because it goes fast making further acceleration more difficult, resulting in a speed limit of c. The Ross Model teaches that in order to drive a particle to high speeds, we must drive it with entrons that increase the mass of the particle making it harder to increase the speed, resulting is a speed limit of 1.414c. But since the direction of the entron driven particle becomes circular with very high energy entrons, the forward speed of the particle may not exceed the speed of light.

### Black Holes and Gravity

Each galaxy in our Universe contains at least one Black Hole at its center which provides sufficient gravity to hold together the entire galaxy of many billions of stars and their planets and the moons of the planets. Matter from each galaxy, including the stars, planets and moons, is continually being consumed by the Black Hole. Once consumed we never see the matter again. Scientists do not have a good description as to what happens to the consumed matter. The Ross Model proposes that the consumed matter is broken down by tremendous heat of the Black Hole into atoms and the atoms are broken down into electrons, positrons, protons and entrons. The released entrons add to the heat energy of the Black Hole. The Ross Model proposes that there is within Black Holes an enormous flux of neutrino entrons. Combinations of neutrino entrons positrons and electrons produce a large population of anti-protons at a controlled rate that depends of the population of positrons, electrons and neutrino entrons. Each anti-proton soon after production combines with a proton and both are annihilated releasing two neutrino entrons, some of which participate in the production of more anti-protons and some of which escape the Black Hole as neutrino photons to provide the gravity of the galaxy.

The neutrino photons traveling out travel out from the Black Hole at the speed of light. Coulomb force waves spread out spherically from each photon at the speed of light. (Remember a neutrino photon is a single neutrino entron traveling in a circle at a speed of 2c within the neutrino photon which is traveling at a speed of c.) Neutrino entrons are so small, their photons pass easily through almost all objects in their path including objects as small as the nuclei of atoms. Therefore, objects in the path of the neutrino photons do not feel the Coulomb forces from the neutrino photons until the neutrino photons have passed by or through the objects. Thus, there is no force on the objects in the direction of travel of the neutrino photons. Sidewise forces produced by fluxes of neutrino photons cancel so the only force felt by the objects, through which or by which the neutrino photons are passing, is a force pushing the objects back toward the source of the neutrino photons, i.e. the Black Hole. The flux of neutrino photons leaving the Black Hole is so extensive that normally nothing other than the neutrino photons can leave the Black Hole. This includes all other photons in the electromagnetic spectrum, including visible light, infrared light, ultraviolet light radio waves, x-rays and gamma rays. According the Ross Model there is a gap in the electromagnetic spectrum between high energy gamma rays and neutrino photons. Also, the Ross Model proposes that all neutrino photons have the exact same energy and wavelength and they do not compete with each other. This is due to the fact that all neutrino entrons are preserved as an integral part of a proton except when it is functioning a carrier of gravity. In both cases it has no occasion to gain or lose energy.

Gravity, according to the Ross Model, is produced in Black Holes with the destruction of protons and anti-protons which releases one neutrino photon with each proton and each anti-proton destroyed. Atoms, including their nuclei, according to the Ross Model, are comprised of nothing but electrons, positrons and entrons. The size of electrons and positrons is about 2×10⁻¹⁸ m, which is about a thousand times smaller than a proton and one hundred million times smaller than an atom. Entrons cannot capture another entron, so electrons and positrons are the only things that can capture a neutrino entron. These tiny particles represent a cross section for capture that is many trillions times smaller than the cross section of atoms. The neutrino entron in each neutrino photon has a diameter of about 1.46×10⁻¹⁸ m (about the same size as the electron and the positron). So the neutrino photon easily passes through objects like stars, planets and moons, molecules, atoms and even protons. An extremely small percentage of the neutrino entrons are temporally captured by electrons and positrons in objects such as the stars, planets and moons. These captured neutrino entrons are later released in random directions as neutrino photons; thereby giving these stars, planets and moons their gravity. Coulomb force effects from the tronnies in each neutrino photon produce tiny forces on the charges in the objects through which the neutrino photons pass, pushing the objects back toward the source to the neutrino photons (i.e. Black Holes). Electrons in hydrogen atoms in interstellar space capture or scatter a portion of the neutrino photons to significantly reduce the neutrino photon flux from each galaxy that reaches far distant galaxies.

### Production of Neutrino Entrons in Black Holes

According to the Ross Model, neutrino entrons and neutrino photons are produced in Black Holes when the neutrino photons are released with the destruction of protons in the cosmic matter that is sucked into the Black Hole by its extreme gravity. For example a planet the size of the earth would have a mass of about 5.98×10²⁴ kg. Since almost all of that mass of the planet is contained in protons and since protons have a mass of about 1.67×10⁻²⁷ kg, there must be about 3.6×10⁵¹ protons in a planet the size of the earth. Since each proton is comprised of one neutrino entron, the planet would carry into the Black Hole about 3.6×10⁵¹ neutrino entrons which sooner or later would be converted to neutrino photons. So let us try to get an idea of the extent of the neutrino photon flux in our solar system as a consequence of activity at our Black Hole. To begin with we are about 2.2×10²⁰ meters from the location of the Black Hole at the center of our Universe. We will now try to calculate how much neutrino photon activity we could expect at our position in our Universe as a consequence of an earth size mass being consumed in the Black Hole.

The surface area of a sphere with a diameter of 2.2×10²⁰ m is determined by the formula: A=4πr², so the surface area at the earth's position in the Milky Way Galaxy is 1.36×10⁴¹ m². We assume that all of the neutrino photons released by the destruction of a planet the size of the earth would be distributed evenly over the surface area of a sphere with a radius equal to the distance equal to the distance between the earth and the center of our galaxy. Now we want to know the number of neutrino photons per square meter at the earth's position in the galaxy. We get that number by dividing 3.6×10⁵¹ neutrino photons by 1.36×10⁴¹ m². The result is 2.64×10¹⁰ neutrino photons/m² or about 26.4 billion neutrino photons per square meter. So if we assume the Black Hole consumes matter at the rate of one planet earth each day and converts its mass to neutrino photons earth should see a neutrino photon flux of about 26.4 billion neutrino photons per day or if we divide this number by the number of seconds (86,400) in a day we have a neutrino flux of 300,000 photons/m²-second. This may provide a rough estimate of the neutrino photon flux we are actually experiencing that is holding our solar system in its circular path through our Milky Way Galaxy. Since our bodies have a cross section of about 0.5 square meters (with these assumptions) we, ourselves are being penetrated each second by about 150,000 neutrino photons each second from the Black Hole in the center of our galaxy. Although it is not pleasant to be riddled by so many neutrino “bullets” each second of our lives, we need to keep in mind that were it not for these tiny photon bullets, we, our earth and our sun would not be maintained in our respective positions in our Universe. In fact it is difficult to imagine what our Universe would be like without these tiny gravity producing bullets.

### Anti-Gravity

Anti-gravity is produced by photon pressure from low-energy photons such as visible light photons which pass through interstellar space basically unimpeded, much more efficiently than gravity producing neutrino photons. Therefore, photon pressure from stars of one galaxy is sufficient to provide a repulsive accelerating force on far distant galaxies. This force is small but it is constant and continuous (always accelerating every second) for billions of years. Thus, close-by galaxies are all accelerating toward each other due to the influence of neutrino photons which pass through the stars, planets and moons of the close by galaxies, and far-away galaxies are expanding away from each other due to pressure from lower energy photons which are absorbed by or reflect from the stars, planets and moons of the far-away galaxies. So the things responsible for the attraction and repulsion of galaxies are photons, nothing but photons, low energy photons pushing far away galaxies apart and neutrino photons pulling close-by galaxies together!

### Our Universe is Contained in a Cold Plasma Shell

The Ross Model describes a cold plasma shell (of mostly naked electrons, positrons and protons) which surrounds and contains our Universe. This cold plasma shell has reflected low energy photons from the galaxies of our Universe like an integrating sphere since the formation of our Universe and it has absorbed neutrino photons and high energy photons. Therefore, photons do not escape from our Universe. Reflected low energy photons produce the recently discovered uniform (in every direction) low-energy cosmic background radiation. The electrons in the cold plasma shell absorb the entrons of neutrino photons reaching the shell to produce very high-energy electrons each of which may capture two positrons to produce a new proton which collects gamma rays to become a hydrogen nuclei which in turn can collect an electron to become hydrogen atom providing material for the production of new galaxies at the currently growing boundary of our Universe.

### Coulombic Grids

As I have emphasized many times our Universe is comprised of nothing but tronnies and things made from tronnies. Each tronnie is a point charge, either plus or minus. And each of these charges posses the Coulomb force which travels our from the tronnie as a continuously expanding spherical waves at the speed of light applying to the Coulomb force (attractive or repulsive) to other tronnies. These other tronnies include the three tronnies of electrons and positrons and the two tronnies making up the entron in each photon. In portions of our Universe where a lot of mass is concentrated the aggregation of all of these Coulombic force waves create thick Coulombic grids. We can imagine simple and complicated Coulombic grids. For example, imagine a cubic meter in intellar space far away from any galaxy. The only tronnies in this space would be those contained in the few atoms of hydrogen that float around in interstellar space (estimate to be about one atom per cubic meter) plus the tronnies in photons of a variety of energies from the far away galaxies randomly directed photons of the cosmic background radiation. The combined Coulomb forces at any time from the tronnies in this cubic meter of space would set up a Coulombic grid that on the average is approximately stationary relative to the center of our Universe; however, the grid is made up of Coulombic waves all moving at the speed of light in random directions. Let's refer to this grid as our “universal Coulombic grid” and for the time being, let's assume that it truly is universal, i.e. the same everywhere in our Universe. We should understand however that this grid may be expanding out from the center of our Universe but let's avoid that issue for now. Next let's imagine a cubic meter of space located within our Milky Way Galaxy. This cubic meter would be similar to the cubic meter we just considered except there would be substantially more photons passing through and probably significantly more atoms floating around, so the Coulombic grid would be denser. A very significant difference however would be that most of the photons would be coming from the 100 billion stars within the galaxy all of which are moving through the galaxy at high speeds around the center of the galaxy and the galaxy itself is moving through space at a high speed. A similar situation would apply to other galaxies in our Universe. So the Coulombic grids within most (if not all) galaxies are all moving at high speeds with respect to the universal Coulombic grid. And since most (if not all) galaxies are moving at high speeds with respect to each other, their Coulombic grids are moving at high speeds with respect to each other. Also our sun and our solar system and all of the atoms and photons associated with the solar system is moving through our Milky Way Galaxy at a high speed relative to the Coulombic grid of our galaxy. Therefore, a Coulombic grid is defined by our solar system and this Coulombic grid is moving through space at a high velocity along with the solar system. And lastly our earth is moving through the Colombic grids of the solar system and the Milky Way galaxy at a high speed relative to those grids. All of the atoms of our earth and its atmosphere and the photons produced by or reflected from our earth and its components define “an earth Coulombic grid” that is moving through space at the same speed that our earth moves through space. You may ask, “Why is all of this important?” It is important because according to the Ross Model, light travels through Coulombic grids at the speed of light (c=3×10⁸ m/s) relative to the Coulombic grid it is passing through. Therefore, if a beam of light passing through interstellar space at a speed of c illuminates a galaxy moving at a speed of 0.1 c opposite the beam of light the beam of light will slow down to 0.9 c while it passes through the galaxy. Anyone in the galaxy measuring the speed of the beam will measure its speed a 1.0 c. On the other hand if the galaxy is moving through space at a speed of 0.1 c in the direction of the light beam the light beam will speed up to 1.1 c while it passes through the galaxy and the people measuring its speed will measure its speed as 1.0 c. The same analysis applies to measurements of the speed of light on earth. Earth carries its own Coulombic grid so any light passing through the earth and its atmosphere will slow down or speed up so that its speed as it passes through is the speed of light (i.e. 3×10⁸ m/s).

### Light Beams Create Speed of Light Coulombic Grids

According to the Ross Model photos are entrons traveling in a circle at a speed of 2c and forward at the speed of c all as shown in FIGS. 3 and 4. As photons in a beam of light pass through space at the speed of light their the tronnies of each of their entrons are producing Coulombic waves that creates a Coulombic grid moving at the speed of light through the Coulombic grid the light beam is passing through. How can this be? Let's figure. How many tronnies are there in a typical beam of light. Let's take a beam of visible light created by a 100 watt incandescent light with a reflector large enough to create a one square meter light beam. Let's assume that the light system is 20 percent efficient so the energy of all of the photons is 20 watts. (A watt is equivalent to 1.0 joule per second, 1.0 J/s). The energy of visible light photons is about 2 eV/photon or 3.2×10⁻¹⁹ J/photon. This means that the beam of light must contain about:

(20 watts)(1 J/s-watt/m²)/(3.2×10⁻¹⁹ J/photon)=6.25×10¹⁹ photons/s-m²

passing through this one meter square beam. The beam is moving at the speed of light (3×10⁸ m/s) so in the beam the density of photons must be about:

$$\begin{matrix}photons \text{/} {m}^{3} = \frac{6.25 \times {10}^{19} photons \text{/} s - {m}^{2}}{3 \times {10}^{8} m \text{/} s} \\ = 2.08 \times {10}^{11} photons \text{/} {m}^{3}\end{matrix}$$

Thus, a typical focused light beam from a 100 watt lamp produces a density of about 200 billion charges per cubic meter moving through space at the speed of light. These 200 billion charges per cubic meter creates its own Coulombic grid that is moving at the speed of light through space.

### Where do Tronnies Get their Charges?

The Ross Model proposes that everything in our Universe is made from tronnies having no mass, no volume and a charge of plus or minus e. We all can image no mass and we all can image no volume. But what is charge anyway? And more specifically what is a charge of e. Scientist tell us that charge is a property of things such as electrons and protons. They know that the electron has a charge of minus e (about 1.602×10⁻¹⁹ coulombs) and they know that the proton and the positron have charges of plus e. They also know that charges produce a force, the Coulomb force either attractive or repulsive on other charges. But scientist do not have a good explanation as to how the electrons, positrons and protons acquired their charges.

As you the reader are very well aware by now that the Ross Model proposes that all charges are carried by tronnies, in fact I think we could say that each tronnie is a charge since charge is the only property it possesses. It has no mass and no volume, only charge. Furthermore, that charge is exactly constant never diminishing, never increasing even though each tronnie is continually utilizing that charge to propel itself as fast or faster than the speed of light and in most cases also help propel other tronnies or other particles. So the question for this section is: “Where do tronnies get their charge?”

The Ross Model proposes that each and every tronnie gets its charge from the Coulombic grid through which it is traveling. Remember every tronnie is always traveling at the speed of light or faster. We learned in a previous section that our Universe is filled completely with Coulombic grids made up of Coulomb force waves all traveling at the speed of light. These speeds of light are all relative to some frame of reference. If you can imagine a 60 gram glass ball the size of a baseball traveling at 100 miles per hour relative to our Milky Way Galaxy in a direction away from our galaxy through interstellar space half way between our galaxy and our nearest galactic neighbor. That 60 gram glass ball contains about 6.023×10²³ atoms of silicon and twice as many atoms of oxygen. Each atom of silicon contains 28 protons and 28 electrons and each atom of oxygen contains 16 protons and 16 electrons. Each electron contains at least 3 tronnies (2 minus tronnies and 1 plus tronnie) and each proton contains at least 11 tronnies, (6 plus tronnies and 5 minus tronnies). In addition the glass ball contains a bunch of entrons with two tronnies each which we won't bother counting. So I think we have within this little glass ball more than 5×10²⁶ charges each carrying a charge of e and producing Coulomb force waves which are traveling through the glass ball and passing out from it through our Universe. According to my math 5×10²⁶ is equal to 500 billion-trillion charges in this little glass ball. This is 500 billion-trillion tronnies each one repelling itself and all other like tronnies and attracting unlike tronnies. Furthermore, the combination of all of the force waves from the tronnies (each moving faster than the speed of light) is creating a Coulombic grid within the ball that is moving at 100 miles per hour through interstellar space. We can think of a photon from our galaxy may be approaching the ball at the speed of light relative to the Coulombic grid at that location in interstellar space. When the photon enters the ball it will adjust its speed so as to travel at the speed of light through the Coulombic grid of the glass ball. The photon's speed as it passes through the ball is determined by the index of refraction of the glass and the speed of the ball relative to interstellar space. The index of refraction of the glass relative to interstellar space will cause a decrease in the photon's speed but the balls 100 mph speed in the direction of the photon will cause an increase in its speed. I have not figured out whether the photon speeds up or slows down as it passes through the ball. The point of this example is that the tronnies in the ball are creating a Coulombic grid that travels with the ball and controls or helps control the speed of light in the ball.

My other point that I am attempting to make here is that the Coulombic grid inside a little glass ball includes a tremendous number of Coulombic forces all traveling at the speed of light. Now the questions is: Could all of these 500 billion-trillion charges packed into a tiny glass ball create a grid of forces moving at the speed of light that could focus themselves into 500 billion-trillion points that are moving through our Universe at the speed of light and also circling at speeds faster than the speed of light. If so, we may have answered the question of where tronnies get their charge. The answer would be they get it from themselves and other tronnies.

In support of this proposition we may consider FIG. 2B. If you could imagine shrinking yourself down sufficiently so you could catch a ride on Tronnie P, you would see Tronnie N at location 204 at the instant of the FIG. 2B snapshot. However, as you (riding on Tronnie P) circle along the circumference of entron 199 you will perceive tronnie N making perfect circles around you at a distance of b=0.59461d′. You would also see Tronnie P (that you are riding on) circling you and Tronnie P at a distance of d′. The Coulombic force waves from both tronnies are focused on you and Tronnie P at all times. A similar analysis can also be made with respect to the electron as shown in FIG. 5. As in the case of the entron, the tronnies of the electron are looping around each other faster than the speed of the coulomb force waves so each one is continually receiving Coulomb force input from themselves and other tronnies. Protons are merely combinations of negative and positive electrons and entrons. Photons are made of entrons.

Since I cannot think of any other way that a tronnie could get its charge (a charge that never diminishes), at least for now, I propose that tronnies obtain their charge from themselves and other tronnies and that each tronnie always move along paths through our Universe so that it receives the precise amount of Coulombic forces from itself and other tronnies to sustain its charge at a charge of e.

### VARIATIONS

Persons skilled in this art will recognize that many changes and variations to the specific embodiments of the present invention are possible so the reader should understand that the scope of the present invention should be determined by the appended claims and their equivalents.

I claim:

1. A process for making models of elements of our Universe comprising steps of:
A) creating a representation of a fundamental point particle having zero mass, zero volume and a charge of about plus 1.909×10⁻¹⁹ coulomb, defining a plus tronnie or minus 1.909×10⁻¹⁹ coulomb defining a minus tronnie, each of which fundamental point particle is self-propelled at speeds never less than the speed of light,
B) utilizing such representations of point particles to create models of small particles each of the small particles having a mass.

2. The process as in claim 1 wherein said small particles are subatomic particles.

3. The process as in claim 1 wherein the small particles include a particle comprised of nothing but one plus tronnie and one minus tronnie circling a common center and defining an entron and an entron diameter.

4. The process as in claim 3 wherein the two tronnies are modeled as circling at speeds of about 1.57c.

5. The process as in claim 3 wherein a photon is modeled as being comprises of nothing but an entron.

6. The process as in claim 5 wherein the entron is modeled as traveling in a circle at a speed of 2c and forward at a speed of c.

7. The process as in claim 1 wherein a naked electron is modeled as being comprised of a plus tronnie circling with a diameter of about 0.933×10⁻¹⁸ m and two minus tronnies circling the path of the plus tronnie also with a diameter of about 0.933×10⁻¹⁸ m, the time for a complete circle defining an electron period.

8. The process as in claim 7 wherein said two minus tronnies are modeled as circling behind the plus tronnie by one fourth of the electron period.

9. The process as in claim 8 wherein a positron is modeled an anti-particle of the electron.

10. The process as in claim 3 wherein an entron is modeled as having a diameter of about 0.933×10⁻¹⁸ m and defining a neutrino entron.

11. The process as in claim 10 wherein the neutrino entron is modeled as a carrier of gravity.

12. The process as in claim 1 wherein a naked proton is modeled as being comprised of a high-energy electron with a captured neutrino entron, with the high-energy electron traveling in a circle with a diameter of about 0.85×10⁻¹⁵ m and two low-energy positrons circling the path of the high-energy electron.

13. The process as in claim 12 wherein a hydrogen one nucleus is modeled as being comprised of a naked proton with a plurality of captured entrons.

14. The process of claim 13 wherein the captured entrons are modeled as having a combined energy of about 8.37 MeV.

15. The process as in claim 14 wherein at least a portion of the combined energy of about 8.37 MeV is modeled as being released in the course of hydrogen fusion to produce helium.

16. The process as in claim 1 wherein our Universe is modeled as having an approximately spherical shell comprised of naked electrons and naked positrons many light years thick.

17. The process as in claim 1 wherein our Universe is modeled as being created at the same time as the demise of our predecessor universe.
